(19) United States
(12) Patent Application Publication
(10) Pub. No.: US 2018/0300935 A1
(43) Pub. Date: Oct. 18, 2018

(54) STORAGE MEDIUM, RENDERING METHOD AND DATA STRUCTURE

(71) Applicant: Live2D Inc., Tokyo (JP)

(72) Inventors: Yuta IMAI, Tokyo (JP); Shuichi INADA, Tokyo (JP)

(21) Appl. No.: 15/950,824

(22) Filed: Apr. 11, 2018

Related U.S. Application Data
(60) Provisional application No. 62/485,257, filed on Apr. 13, 2017.

(30) Foreign Application Priority Data
May 31, 2017 (JP) 2017-108294

(51) Int. Cl. G06T 15/00; G06T 15/20; G06T 19/20; G06T 11/40

(52) U.S. Cl. CPC G06T 15/005; G06T 15/205; G06T 2200/04; G06T 11/40; G06T 19/20

(57) ABSTRACT

For a state for which a rendering object presentation request was made, attribute spaces for which to perform an interpolation calculation for state information are decided based on an attribute table and a state table, state information of a state for which the presentation request was made is derived by, for each of the decided attribute spaces, performing the interpolation calculation, and the rendering object is then presented. In the derivation, for each of the decided attribute spaces, an interpolation calculation is performed using difference information managed by that attribute space, and by adding a sum total of the interpolation calculation results to state information of a reference state, the state information of the state for which the presentation request was made is derived.

### BACKGROUND OF THE INVENTION

### Field of the Invention

The present invention relates to a storage medium, a rendering method and a data structure, and particularly to a technique that makes it possible to, by causing an outer appearance of a two-dimensional image to change, present a three-dimensional rendering expression of the image.

### Description of the Related Art

There are techniques that make a three-dimensional rendering expression of a two-dimensional image such as a character drawn by a designer possible by transforming, in accordance with set parameters, the two-dimensional image (Japanese Patent Laid-Open No. 2009-104570). More specifically, a technique in which, by defining, in a form intended by a designer, states for a given parameter in relation to an expression definition part (rendering object/art mesh/part group) for a target object (two-dimensional image), an outer appearance of a two-dimensional image is caused to change dynamically in accordance with a change in the parameter by interpolating from a defined state for the parameter to generate an undefined state for the parameter, is disclosed in Japanese Patent Laid-Open No. 2009-104570.

In Japanese Patent Laid-Open No. 2009-104570, configuration is such that for a rendering object such as an eye, a nose, a mouth, or the like, to be arranged on a face of a character, for example, by defining an arrangement in a single curved surface that expresses the face, even when the curved surface is transformed to a shape according to a viewing direction (parameter), it is possible to perform mapping in a form that takes this transformation into consideration, and applies movement or transformation in accordance with the curved surface collectively.

Incidentally, in a case where mapping to a curved surface is included in processing as in Japanese Patent Laid-Open No. 2009-104570, after applying a transformation that occurs for each rendering object (arranged object) that is arranged on the curved surface, a final output image is generated by performing a mapping to the curved surface after the transformation in accordance with separate parameters. At that time, by the designer adding fine adjustments to the arranged objects in the output image, an expression that the designer desires is realized for a particular parameter value set.

Meanwhile, by having such a two-stage process (transformation according to parameters (facial expression, or the like) other than viewing direction for the arranged objects+transformation of the curved surface according to a viewing direction parameter and arrangement including coordinate conversion of arranged objects on the curved surface), in a case where an adjustment performed for a particular parameter value set results in an another parameter value set, an expression that is not intended by the designer may result. That is, while collective object arrangement according to a movement transformation of a curved surface is possible by using a curved surface, an expression that is not intended may be presented due to a constraint with mapping to the curved surface, and so it was necessary for the designer to repeat work while confirming and finely adjusting various parameter value sets until a desired expression that does not collapse is realized. In particular, in a case in which a parameter accompanying a transformation or the like for a particular arranged object is additionally defined, so that a suitable expression will result in a case where a mapping to the curved surface is performed rather than just a transformation of a rendering object according to that parameter, definition by the designer for a plurality of states (2ⁿ for n parameters in Japanese Patent Laid-Open No. 2009-104570) that are the foundation for interpolation calculation was necessary, and the work burden on the designer could increase exponentially in accordance with the addition of a parameter for the expansion of the rendering expression.

In particular, in the method of Japanese Patent Laid-Open No. 2009-104570, regarding a two-dimensional image corresponding to one cut, a range for a viewing direction in which a three-dimensional rendering expression is possible is limited to an expression in which that two-dimensional image is used. In other words, in a case where a viewing direction range is extended to an omnidirection, for example, it is necessary to switch a rendering object group used for a three-dimensional rendering expression in accordance with a change in viewing direction in order to express that the rendering objects that become visible in accordance with the viewing direction will change or to realize a desired rendering expression in relation to a particular viewing direction such as an external characteristic of a character.

Accordingly, it is advantageous to make the difference in the rendering expression of the shape, or the like, of a rendering object before/after the switch smaller so not to give the viewer a sense of discomfort in a case of occurrence of a transition due to such a switch, but in a method involving mapping to the curved surface, since an adjustment for one parameter value set may influence a rendering expression for another parameter value set, there is a possibility that the designer will be forced to perform complex adjustment work until a suitable transition is realized.

With respect to this, a method that does not perform mapping to a curved surface and realizes a desired rendering expression by increasing the number of parameter types and making it possible to finely adjust a rendering object can be considered, but since, in the interpolation calculation required prior to output of a rendering expression involving parameter modification, the amount of information to be referenced and the calculation amount may increase exponentially in proportion thereto, there is a trade-off relation between performance of reproduction of an intended rendering expression and calculation amount necessary for rendering expression presentation.

### SUMMARY OF THE INVENTION

The present invention was made in view of such problems in the conventional technique. The present invention provides a storage medium, a rendering method and a data structure that facilitate desired rendering expression adjustment and reduce calculation load.

The present invention in its first aspect provides a non-transitory computer readable storage medium storing a program for presenting a rendering object for a requested state, wherein the program causes a computer, comprising a memory in which an attribute table that manages a plurality of types of attributes arranged for the rendering object and whether or not there is relatedness between attributes and a state table that manages an attribute value set for which a state definition was performed and state information indicating a corresponding defined state, to execute: processing for obtaining a presentation attribute value set configured by attribute values that identify a state of the rendering object for which a presentation request was made; processing for deciding, for the state for which the presentation request was made, attribute spaces for which to perform an interpolation calculation for state information based on the presentation attribute value set, the attribute table, and the state table; processing for deriving state information of the state for which the presentation request was made by performing the interpolation calculation for each of the decided attribute spaces; and processing for presenting the rendering object based on the derived state information, wherein a reference state, which is identified by the plurality of types of attribute values all being reference values, is defined for the rendering object, each of the plurality of types of attributes and each group of attributes having relatedness form an individual attribute space, and the state table manages a difference of state information from the reference state for the defined state as difference information by separation into corresponding attribute spaces, and in the processing for deriving, for each of the decided attribute spaces, the interpolation calculation is performed by using the difference information which is managed for a state defined for that attribute space, and the state information of the state for which the presentation request was made is derived by adding a sum total of interpolation calculation results of the decided attribute spaces to state information of the reference state.

The present invention in its second aspect provides a rendering method for presenting a rendering object for a requested state, comprising: obtaining an attribute table that manages a plurality of types of attributes arranged for the rendering object and whether or not there is relatedness between attributes and a state table that manages an attribute value set for which a state definition was performed and state information indicating a corresponding defined state; obtaining a presentation attribute value set configured by attribute values that identify a state of the rendering object for which a presentation request was made; deciding, for the state for which the presentation request was made, attribute spaces for which to perform an interpolation calculation for state information based on the presentation attribute value set, the attribute table, and the state table; deriving state information of the state for which the presentation request was made by performing the interpolation calculation for each of the decided attribute spaces; and presenting the rendering object based on the derived state information, wherein a reference state, which is identified by the plurality of types of attribute values all being reference values, is defined for the rendering object, each of the plurality of types of attributes and each group of attributes having relatedness form an individual attribute space, and the state table manages a difference of state information from the reference state for the defined state as difference information by separation into corresponding attribute spaces, and in the deriving, for each of the decided attribute spaces, the interpolation calculation is performed by using the difference information which is managed for a state defined for that attribute space, and the state information of the state for which the presentation request was made is derived by adding a sum total of interpolation calculation results of the decided attribute spaces to state information of the reference state.

The present invention in its third aspect provides a data structure that is used for presenting a rendering object for a requested state, and that manages states of that rendering object for which a state definition was performed, the data structure comprising: first information that manages a plurality of types of attributes arranged for the rendering object and whether or not there is relatedness between attributes; and second information that manages an attribute value set for which a state definition was performed and state information indicating a corresponding defined state, wherein a reference state, which is identified by the plurality of types of attribute values all being reference values, is defined for the rendering object, each of the plurality of types of attributes and each group of attributes having relatedness form an individual attribute space, and the second information manages a difference of state information from the reference state for the defined state as difference information by separation into corresponding attribute spaces.

Further features of the present invention will become apparent from the following description of exemplary embodiments (with reference to the attached drawings).

### BRIEF DESCRIPTION OF THE DRAWINGS

FIG. 1 is a block diagram for showing a functional configuration of a PC 100 according to an embodiment of the present invention.

FIG. 2 is a view that exemplifies a GUI of a keyform editing application according to an embodiment of the present invention.

FIGS. 3A and 3B are views for describing data storage when editing a keyform in the keyform editing application according to an embodiment of the present invention.

FIG. 4 is a view for describing a key relationship according to an embodiment of the present invention.

FIGS. 5A, 5B, and 5C are views for describing derivation of state information by an interpolation calculation for a parameter value set of a multi-dimensional parameter space according to an embodiment of the present invention.

FIGS. 6A, 6B, and 6C are views for describing data conversion for output according to an embodiment of the present invention.

FIGS. 7A, 7B, and 7C are other views for describing data conversion for output according to an embodiment of the present invention.

FIG. 8 is a flowchart that exemplifies parameter key setting processing that is performed by a PC 100 according to an embodiment of the present invention.

FIGS. 9A and 9B are flowcharts that exemplify keyform editing processing that is performed by the PC 100 according to an embodiment of the present invention.

FIGS. 10A and 10B are flowcharts exemplifying processing for updating a base keyform and a keyform according to an embodiment of the present invention.

FIGS. 11A and 11B are flowcharts that exemplify reflecting processing according to an embodiment of the present invention.

FIGS. 12A, 12B and 12C are flowcharts that exemplify display processing at the time of editing according to an embodiment of the present invention.

FIG. 13 is a view for describing an interpolation calculation according to an embodiment of the present invention.

FIGS. 14A, 14B and 14C are flowcharts that exemplify runtime data output processing according to an embodiment of the present invention.

FIGS. 15A and 15B are views for comparing calculation efficiency with that of a conventional method according to an embodiment of the present invention.

### DESCRIPTION OF THE EMBODIMENTS

### Embodiments

Exemplary embodiments of the present invention will be explained hereinafter in detail, with reference to the drawings. Note that in an embodiment described below, an example that applies the present invention to a PC, which is one example of an apparatus for realizing the present invention and in which a group of parts respectively configured in a two-dimensional image (texture) are transformed, and a three-dimensional rendering expression according to a rendering object is presented, will be described. However, the present invention can be applied to any device capable of realizing a presentation of a rendering object for a requested state based on an attribute table and a state table configured for the rendering object.

### Term Definitions

First, fundamental terms that will be used in the present specification will be described.

“Parameter” means an attribute (variable) that is associated with a rendering object which is a presentation target, and a given numerical range is assigned thereto. A user can select a status of a rendering object by modifying a value (parameter value) of a corresponding attribute. An associated parameter need not be something that is fixed and indicates an attribute of a concept that is defined in advance such as a viewing position or a viewing direction, and may include any concept that the user set as an index for a status modification. Specifically, a parameter associated with a rendering object is a variable for specifying a status, and since a user can freely define how a state of a rendering object is caused to change depending on the variable, a parameter can be set without being limited a fixed concept. Accordingly, there may be a plurality of types for parameters associated with a rendering object. Presentation of a rendering object is performed for each status.

Also, for each parameter, a “parameter key”, which is a definition point indicating an upper limit value/lower limit value that stipulates a numerical range or a constant in a numerical range, is defined. A parameter key includes at least a definition point set as a reference value, and is assumed be managed in a parameter key list for each parameter type.

Also, each parameter forms a “parameter space (attribute space)” in which a status is modified in accordance with a value of a particular variable. Note that parameters of a plurality of types associated with a rendering object need not indicate variables of independent concepts, and may be related. For example, association between parameters may be performed considering the necessity of variables of a plurality of types according to a single concept, such as a pitch angle and a yaw angle in accordance with a viewing direction. In such a case, for each parameter, in addition to a one-dimensional parameter space formed in accordance with the single variable, a multi-dimensional parameter space in which a status is modified in accordance with a plurality of variables is formed for a plurality of related parameters. Here, the number of dimensions of the parameter space corresponds to the number of variables used to identify a status in the space, and in the viewing direction example described above, the number of dimensions of the parameter space formed for the pitch angle and the yaw angle is two (two-dimensional parameter space).

Also, a status that can be used in an interpolation calculation according to a presentation, among statuses of a rendering object, is referred to simply as a “key” (different meaning to parameter key). Keys are assigned a “keyform index”, which is identification information for identifying a status, and respectively managed thereby. A keyform index is configured by a combination of one or more parameter keys (parameter key set) for specifying a status, and parameter values of a sufficient number (types) needed to specify a status are included in the combination. Here, the keyform index may be something that identifies a status in one of the parameter spaces formed for a rendering object, and the sufficient number needed for specification means the number (number of dimensions) of parameters that form a parameter space of a minimum number of dimensions including the key that can be identified by the keyform index. In the above example of a viewing direction, since a key, in which a pitch angle is identified by a value that is different to a reference value and a yaw angle is identified by a reference value, can be specified by a parameter space of the pitch angle, a keyform index configured only by pitch angle parameter keys is assigned thereto.

Similarly to a parameter space, it is assumed that for a key as well, a number dimensions are defined, the number being that of the parameter keys included in an assigned keyform index, and configuration is such that it is possible to specify a parameter space in which information of that key is defined if the keyform index is referenced. Note that a key that is specified by the combination of parameter keys of reference values for all associated parameters is referred to as a “base key”, but while it is specified by all types parameter values, it is configured by reference values only, and therefore it is treated as zero-dimensional (or as something for which there is no concept of dimension).

A “keyform” means a state (shape, color, transparency, or the like) of a rendering object defined by a user for a key (status) to which a keyform index is assigned. A keyform is managed as state information, and a defined state is reproduced in a case where an equivalent status is designated.

<Configuration of the PC 100>

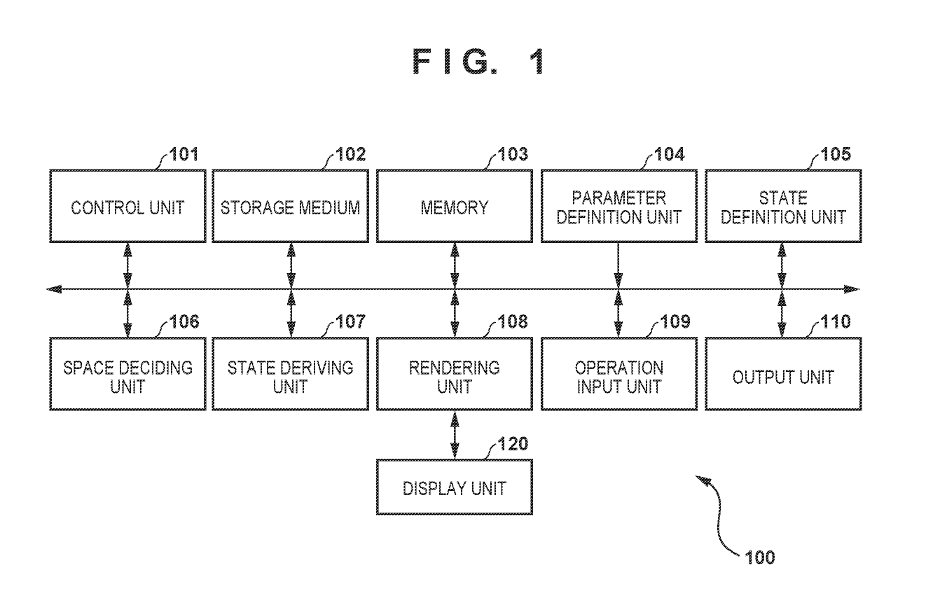

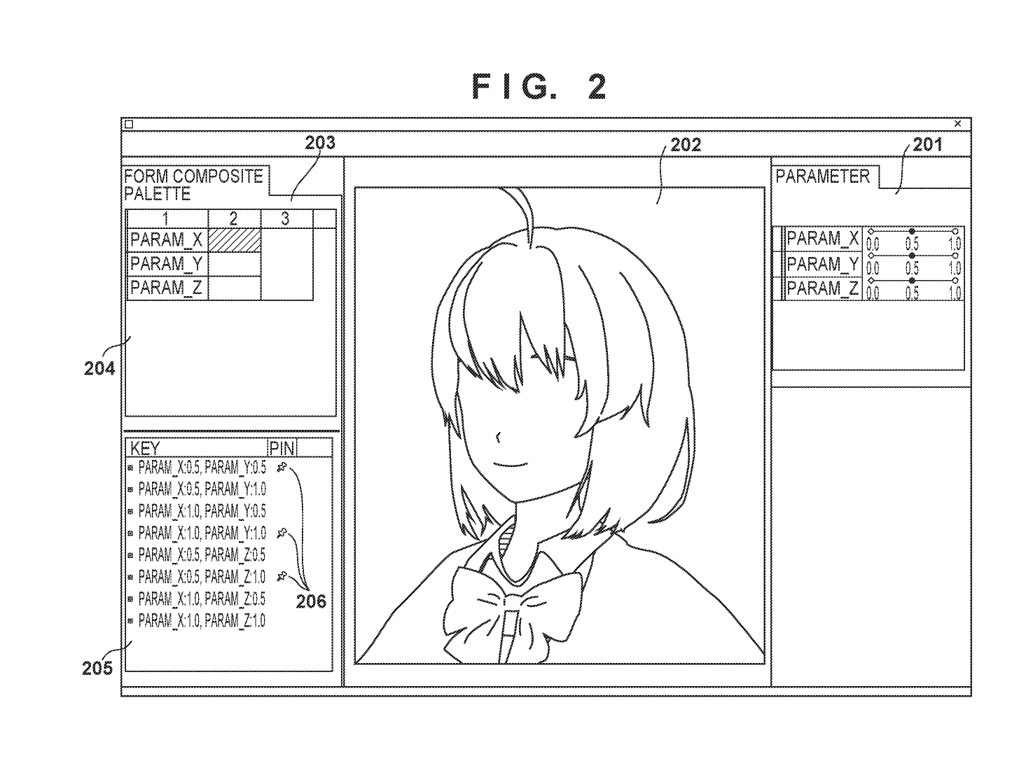

Next, a functional configuration of the PC 100 according to an embodiment of the present invention will be described using a block diagram of FIG. 1. Note that in the PC 100 in the present embodiment, it is assumed that a portion of functional configurations are realized by execution of a program according to a “keyform editing application” that, so as to enable three-dimensional expression of a rendering object configured in a two-dimensional image, performs definition of keyforms and parameters for a rendering object. In this application, as illustrated in FIG. 2, so that a rendering object takes a desired form for a target status, it is possible for a user to define and register a keyform by setting a parameter value set (status) in a parameter palette 201 and editing a group of parts of the rendering object in a viewport (rendering window) 202. Also, for a section configured by at least two parameter keys for which keyforms are defined (in the parameter palette 201, a section is indicated by graduations on a slider for each parameter), a state of the rendering object for a desired parameter value set is presented in the viewport 202 by state information defined for these parameter keys being interpolated. Specifically, it is possible for a user to confirm how the rendering object transitions according to a status modification in a section for which a keyform is defined. Below, the description separates the various functions realized by execution of the program according to the application into blocks, but these may be realized by programs, realized by specific hardware, or realized by using both of these.

A control unit 101 is a control apparatus such as a CPU, for example, and controls operation of each block that the PC 100 has. Specifically, the control unit 101 reads a program according to an operating system stored in a storage medium 102, the program according to the keyform editing application, or the like, and controls operation of each block by loading the program into a memory 103 and executing it.

The storage medium 102 is a storage apparatus such as a non-volatile memory such as a ROM that can be rewritten, for example, or an HDD connected removably to the PC 100. Also, the storage medium 102 may include a storage medium such as a disk in which is recorded a game program that can be accessed via a predetermined interface that can be read from or written to such as an optical drive. The storage medium 102 stores not only the programs described above, but also information such as parameters needed in operation of each block, and various types of data used in rendering object presentation.

The memory 103 may by a volatile memory such as a RAM, for example. The memory 103 is used not only as a loading region for loading programs and the like that are read from the storage medium 102, but also as a storage region for storing intermediate data or the like outputted in operation of each block. During execution of the keyform editing application, it is assumed that a parameter table and a keyform table are managed in the memory 103 as an attribute table and a state table according to the present invention described later.

A parameter definition unit 104 registers parameters to a parameter table in accordance with a user operation in accordance with performance of a request for a new association of a parameter with a rendering object (addition of a new parameter to the parameter palette 201). The parameter table is a table that manages (types of) parameters associated with a rendering object and relatedness between parameters. In other words, a parameter table is a table that manages a parameter space formed for a rendering object, and manages the existence of a one-dimensional parameter space described by each parameter, and, in a case where a plurality of types of parameters are related, multi-dimensional parameter spaces formed by such related parameters.

Also, the parameter definition unit 104, in accordance with a user operation (addition of a definition point to a parameter slider) being performed in accordance with a parameter key addition request, registers information of that parameter key in a parameter key list stored in the memory 103. The parameter key list is a list that manages parameter keys defined for each type of parameter, and for each parameter at least two parameter keys including a reference value are managed. Registration of information in the parameter key list is not limited to cases in which a user operation for an addition request is performed, and parameter keys indicating an upper limit value and a lower limit value (one is a reference value) of a corresponding numerical range may be registered when a new parameter association request is made.

Also, the parameter definition unit 104, in response to a user operation for requesting a parameter key set modification (selection of one of the parameter keys by using the slider for a respective parameter in the parameter palette 201) being performed, obtains information of a parameter key set that is the target of keyform definition/editing, and stores it in the memory 103 as a current parameter value set. In FIG. 2, black-filled points, among the points illustrated together with the graduations of the sliders for the respective parameters of the parameter palette 201, are currently selected parameter keys, and white-unfilled points are other defined parameter keys. Points indicated by a diamond shape among these points indicate reference value parameter keys. Note that modified parameter values are not limited to values defined as parameter keys. As described above, since the keyform editing application of the present embodiment enables confirmation of a rendering object state transition for values between the parameter keys, the current parameter value set may include values other than the parameter keys.

A state definition unit 105, in response to performance of a user operation (an operation to modify a shape corresponding to a rendering object in the viewport 202, to modify an above/below relationship for parts, to modify a color, to modify transparency, or the like) for modifying a rendering object rendering form (state) or a user operation indicating that modification of a rendering form completed, registers, in a keyform table, information of the current parameter value set (parameter key set) and post-modification keyform information. Details of registration of information to the keyform table are described later, but keyform state information is registered in association with a parameter key set, for which state definition was performed, in that table.

A space deciding unit 106 decides, in accordance with a current parameter value set that was set, a parameter space to be used to derive state information of a rendering object corresponding to that parameter value set. Details are described later, but in the keyform editing application of the present embodiment, in order to reduce a calculation amount and a number of memory accesses, state information for keyforms for which a definition is performed is separated into a plurality of parameter spaces and managed. Consequently, upon presentation of a rendering object, the space deciding unit 106 decides a parameter space to be referenced for state information derivation. Note that in the present embodiment, mainly, a method for deciding a parameter space to be referenced in an interpolation calculation performed in a case where the current parameter value set includes a value that has not been registered as a parameter key is described, but a case in which a current parameter value set is configured by only values that are registered as parameter keys is similar.

A state deriving unit 107 performs processing for deriving state information of a rendering object corresponding to a current parameter value set based on information of a parameter space decided by the space deciding unit 106. More specifically, the state deriving unit 107 performs a calculation (state information addition or interpolation calculation) by referencing state information managed for a state defined in the decided parameter space, and derives state information corresponding to the current parameter value set.

A rendering unit 108 may be a rendering apparatus such as a GPU, for example, and the rendering unit 108 controls generation and updating of images to be displayed on a display region of a display unit 120. In the present embodiment, the rendering unit 108, in addition to various GUI images according to the keyform editing application, modifies a rendering form of a rendering object based on state information derived by the state deriving unit 107, and by rendering the rendering object in accordance with the form after the modification, generates an image to be presented in the viewport 202.

The display unit 120 may be a display apparatus such as an LCD, for example. In the present embodiment, the display unit 120 is described as a configuration element that the PC 100 comprises, but implementations of the present invention are not limited to that. The display unit 120 need not be configured in the same housing as the PC 100, and may be an external display apparatus that is detachably connected to the PC 100.

An operation input unit 109 is a user interface that the PC 100 has, such as a mouse, a keyboard, a pen tablet, or the like, for example. The operation input unit 109 outputs to the control unit 101 a control signal corresponding to the operation input when an operation input performed by a respective interface is detected. Also, the operation input unit 109 notifies to the control unit 101 an occurrence of an event corresponding to the operation input.

An output unit 110, after completion of keyform definition for various statuses of a rendering object in the keyform editing application of the present embodiment, converts the parameter table and the keyform table into an optimized format and outputs them in order to realize, on an external application, an external apparatus, or the like, a presentation of a rendering object that exhibits similar state transitions. In a case where a function that makes possible a presentation of a rendering object based on these tables is provided as a runtime library, there is demand that the function be realized at a low calculation load during execution (runtime) of a main program. Accordingly, unlike a management form that guarantees keyform editing ease for every parameter key set, as with the keyform editing application for which repetitive keyform editing is envisioned, these tables which are referenced at runtime are optimized by the output unit 110 so as to reduce calculation load (calculation amount and number of memory accesses) in presentation of a state of a rendering object according to a desired status.

<Data Management Method Overview>

In the method described in Japanese Patent Laid-Open No. 2009-104570, it is necessary to stipulate states (keyforms) of a rendering object for every combination of editing points (parameter keys) arranged for each parameter if the parameters (variables) that are associated with the rendering object increase. In other words, in a case where three types of parameters (Qx (a horizontal direction angle (yaw) for the viewing direction), Qy (a vertical direction angle (pitch) for the viewing direction), and M (a degree of opening/closing of a mouth)) are defined for a rendering object group corresponding to one character, for example, regarding a three-dimensional space stipulated by the respective parameter keys (a space stipulated by the three types of parameters),

0°≤Qx≤60°,

0°≤Qy≤30°, and

0≤M≤1,

it is necessary to define 2³=8 types of rendering object group states. In other words, a user, by defining eight types of states, (0,0,0), (60,0,0), (0,30,0), (60,30,0), (0,0,1), (60,0,1), (0,30,1), and (60,30,1), for a rendering object, was able to generate a rendering object group state for an arbitrary value in the above-described three-dimensional parameter space range by an interpolation calculation.

Meanwhile, as described above, if the number of parameter types associated with a rendering object group is increased for rendering expression diversification, the number of states that must be defined increases exponentially. Also, in an interpolation calculation for that space, the calculation amount and the number of memory accesses increase since the states defined for the space are referenced, and a weighting calculation ends up being performed.

Accordingly, in the keyform editing application of the present embodiment, in order to realize editing freedom and operability in which definition of intended states is easy, the method of mapping to a curved surface, as in Japanese Patent Laid-Open No. 2009-104570, is eliminated, and a presentation with a suitable rendering expression in which, even if the number of types of parameters is increased in order to realize rendering expression diversification, the calculation load for display and the number of states that the user is caused to define are reduced is realized.

<Data Storage Upon Keyform Editing>

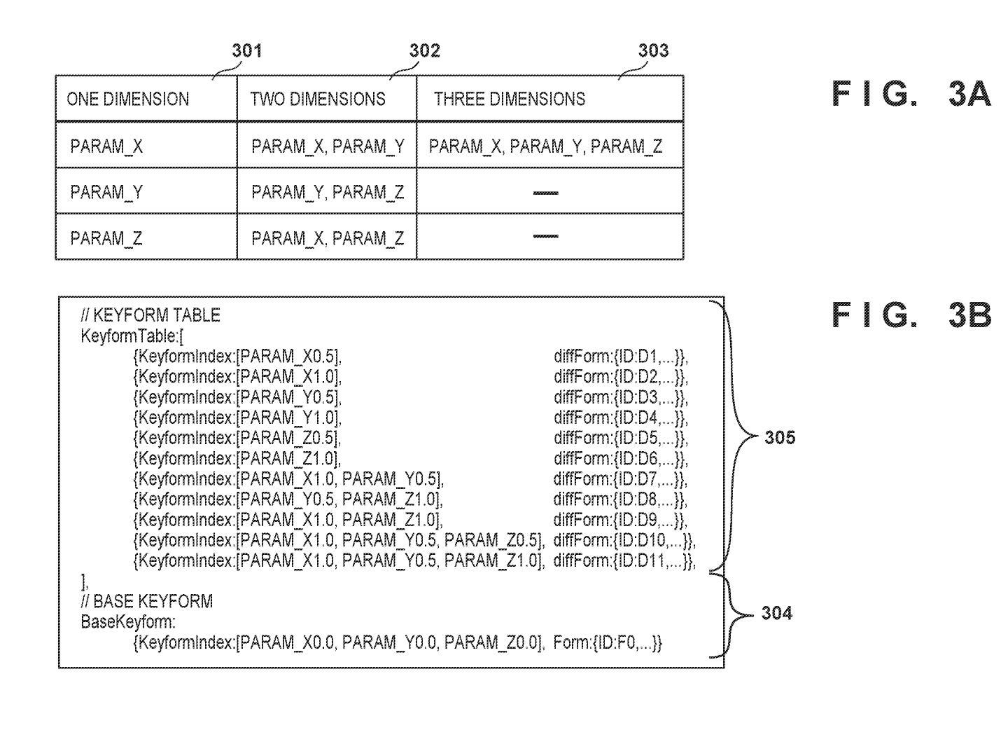

Below, description is given of a data management method that is performed using a parameter table and a keyform table at a time of keyform editing (a state in which it is possible to define a keyform according to any parameter key set) of the keyform editing application of the present embodiment. FIGS. 3A and 3B exemplify the parameter table (FIG. 3A) and the keyform table and a base keyform (FIG. 3B).

As exemplified in FIG. 3A, in the parameter table, for a plurality of types of parameters associated with a rendering object, parameter spaces that are formed according to these and that take in to consideration whether or not there is relatedness between the parameters are managed. In the parameter key combination example of FIG. 3A, the three types, PARAM_X, PARAM_Y, and PARAM_Z, which are related to each other, are associated with the rendering object as parameters, and for each of these parameters, a one-dimensional parameter space 301 ((PARAM_X), (PARAM_Y), (PARAM_Z)) is formed, and for related pluralities of parameters, two-dimensional parameter spaces 302 ((PARAM_X, PARAM_Y), (PARAM_X, PARAM_Z), (PARAM_Y, PARAM_Z)) and a three-dimensional parameter space 303 ((PARAM_X, PARAM_Y, PARAM_Z)) are formed. Also, in a parameter key list (not shown), for each parameter,

PARAM_X: PARAM_X=0.0 (reference value), PARAM_X=0.5, and PARAM_X=1.0;

PARAM_Y: PARAM_Y=0.0 (reference value), PARAM_Y=0.5, and PARAM_Y=1.0; and

PARAM_Z: PARAM_Z=0.0 (reference value), PARAM_Z=0.5, and PARAM_Z=1.0;

are assumed to be managed.

Here, a base key status is identified by a keyform index, KeyformIndex: [PARAM_X0.0, PARAM_Y0.0, PARAM_Z0.0], which are the reference values for all of the parameters. As is described by the definition 304 in FIG. 3B, a base keyform (keyform defined for the base key (default state of the rendering object, for example)) is managed using this keyform index. The base keyform as described by the definition 304 manages state information (Form: {ID:F0, . . . }) of the rendering object in the state of that keyform index in association with the keyform index. The state information managed for the base keyform defines the rendering form of the rendering object absolutely, and may be information that defines absolute coordinates in a coordinate space for rendering for each vertex of a mesh that is assigned to the rendering object, for example.

Meanwhile, keyforms defined for keys other than the base key are managed in a keyform table described in the definition 305 in FIG. 3B in the present embodiment. Here, before describing state information managed in the keyform table, description will be given for handling of keys (for which state definition was already performed (a keyform is already defined)) present in parameter spaces of different dimensions, which are introduced in keyform management of the present embodiment.

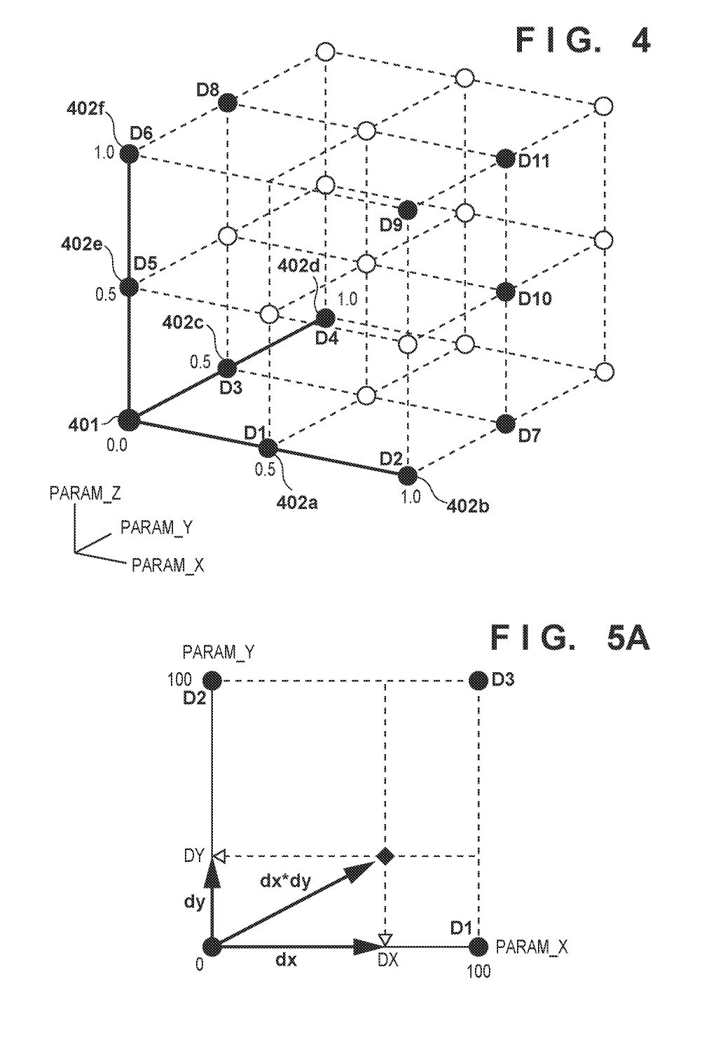

In the keyform editing application of the present embodiment, in order to reduce the number of statuses for which state definition by a user is necessary, configuration is such that while state definition is necessary for the base key and all parameter keys of the one-dimensional parameter space, state definition is optional for keys of parameter spaces of other dimensions. FIG. 4 is a conceptual diagram that illustrates an integration of each parameter space in which PARAM_X, PARAM_Y, and PARAM_Z, which are defined in the parameter table of FIG. 3A, are stipulated.

As illustrated in FIG. 4, state definition is necessary for a base key 401 and one-dimensional keys 402a-f which are arranged for each parameter. Here, an n-dimensional key means a key that indicates a status in a case in which a corresponding n types of parameters are parameter keys other than a reference value, and for which a keyform index is configured by a corresponding n types of parameter keys, and it falls under an n-dimensional parameter space. Meanwhile, other keys (two-dimensional keys and three-dimensional keys) that are identified by a keyform index configured by a combination of parameter keys of a plurality of types are keys for which state definition is not necessary.

Note that it is assumed that when parameter types, relatedness thereamong, and parameter keys set for each parameter are confirmed, keyform indexes for keys for which state definition is possible are added to a keyform list for each parameter space, and managed. For example, in a case where PARAM_X and PARAM_Z are set as related, and the parameter keys PARAM_X=0.5, PARAM_X, =1.0, PARAM_Z=0.5, and PARAM_Z=1.0 are respectively defined, keyform indexes that fall under the two-dimensional parameter space formed between PARAM_X and PARAM_Z and in which state definition can be performed,
KeyformIndex: [PARAM_X0.5, PARAM_Z0.5],
KeyformIndex: [PARAM_X0.5, PARAM_Z1.0],
KeyformIndex: [PARAM_X1.0, PARAM_Z0.5], and
KeyformIndex: [PARAM_X1.0, PARAM_Z1.0],
   are registered in the keyform list for this parameter space. The keyform list manages keys for which keyform definition can be performed, and includes keyform indexes of keys for which a keyform is undefined. Here, it is confirmed whether or not a plurality of types of parameters are related (have relatedness) according to whether or not a state definition was performed for a key for which that plurality of types of parameters are all parameter keys other than the reference values. Specifically, when state definition is performed, a plurality of types of parameters that are other than reference values and which are included in a keyform index of a key for which state definition was performed are set as having a relatedness, and a multi-dimensional parameter space for that plurality of types of parameters is formed.

Keyform indexes for keys for which a state definition is possible for such a parameter space are illustrated in a form composite palette 203 of FIG. 2 in the keyform editing application of the present embodiment. In the example of the figure, a parameter table 204 is illustrated in the top portion of the form composite palette 203, and parameter spaces formed for the rendering object (or one selected part from within the rendering object) are indicated so as to be selectable. Also, in the bottom portion of the form composite palette 203, a keyform list 205 for the selected parameter space in the parameter table 204 is illustrated. The example of FIG. 2 illustrates a state in which the two-dimensional parameter spaces formed to include PARAM_X are selected in the parameter table 204, and keys falling under the corresponding parameter spaces (PARAM_X, PARAM_Y) and (PARAM_X, PARAM_Z) are listed irrespective whether or not there are state definitions therefor.

Also, in the present embodiment, to make it easy to specify a key to be referenced in processing for derivation and definition of state information for each key, the concept of an “derivation relationship” is introduced for management between keys. In the present embodiment, description is given of a form in which specification of a derivation relationship is performed by keyform index and key dimension only, but configuration may be taken such that it is realized by a form in which additional information for specifying a key in a derivation relationship is appended.

In a case of considering an arbitrary key to be a reference, a key that constructs a derivation relationship for derivation from the base key to the arbitrary key is defined to be a “basis key”. Basis keys, in a case of considering an arbitrary key as a reference, indicate: keys that are keys of a lower dimension than the arbitrary key and for which a keyform is defined, and that are specified by a portion of the parameter keys that specify the arbitrary key (the parameter keys included in the keyform index of the arbitrary key) only; and the base key. For example, basis key keyform indexes of a three-dimensional key identified by KeyformIndex: [PARAM_X1.0, PARAM_Y0.5, PARAM_Z1.0] in FIG. 4, are
base key:
   KeyformIndex [PARAM_X0.0, PARAM_Y0.0, PARAM_Z0.0]
one-dimensional keys:
   KeyformIndex: [PARAM_X1.0],
   KeyformIndex] [PARAM_Y0.5], and
   KeyformIndex: [PARAM_Z1.0]
two-dimensional keys: (keyforms are already defined for all)
   KeyformIndex: [PARAM_X1.0, PARAM_Y0.5],
   KeyformIndex: [PARAM_Y0.5, PARAM_Z1.0], and
   KeyformIndex: [PARAM_X1.0, PARAM_Z1.0].
      These keys construct a derivation relationship where the base key is a foundation of the derivation (base key→one-dimensional keys→two-dimensional keys→arbitrary key). Specifically, in the derivation relationship, all keys that correspond to a derivation source of the arbitrary key (tracing back to the base key) are basis keys, and in processing for derivation of state information of the arbitrary key, information managed by the keyform table for these basis keys is referenced.

Meanwhile, in such a derivation relationship, a key corresponding to a derivation destination of the arbitrary key is defined to be a “derivation key”. Derivation keys, in a case of considering an arbitrary key as a reference, indicate keys that are keys of a higher dimension than the arbitrary key and for which a keyform is defined, and that are specified to include all of the parameter keys that specify the arbitrary key. For example, the derivation keys of a two-dimensional key identified by KeyformIndex: [PARAM_X1.0, PARAM_Y0.5] in FIG. 4 are the three-dimensional keys for which a keyform is already defined,

KeyformIndex [PARAM_X1.0, PARAM_Y0.5, PARAM_Z0.5], and

KeyformIndex [PARAM_X1.0, PARAM_Y0.5, PARAM_Z1.0].

Next, in the light of these key derivation relationship concepts, the keyform table illustrated in FIG. 3B will be described. In the keyform editing application of the present embodiment, for keyforms defined for keys other than the base key, difference information that indicates a difference from the base keyform is managed in the keyform table. More specifically, for a keyform according to an arbitrary key, difference information that indicates a difference, for state information (base keyform) of the base key, from a value (state information) derived by summation of a sum total of the difference information managed for all basis keys for the arbitrarily key is managed in association with the keyform index of the arbitrarily key in the keyform table. Here, since difference information is not managed for the base key, the sum total of the difference information managed for all basis keys is the same as the sum total of the difference information of all of the basis keys excluding the base key.

In other words, in a case where a particular keyform is defined for a key that falls under a multi-dimensional parameter space, since parameter spaces of a dimension that the key falls under and parameter spaces of a lower number of dimensions are separately managed in the keyform table, the difference from the base keyform of that keyform can be easily derived by accumulating difference information of the relevant keys. Specifically, for a keyform according to an arbitrary key, in a case where a state definition was performed for that arbitrary key, derivation is possible by taking a sum total of the state information of the base key, the difference information of all of the basis keys, and the difference information of the arbitrary key.

Accordingly, in order to derive a keyform F7 of an already defined three-dimensional key which is identified by KeyformIndex: [PARAM_X1.0, PARAM_Y0.5, PARAM_Z1.0] in the example of FIG. 4, by using the state information F0 of the base keyform, the difference information D2, D3, D6, D7, D8, and D9 of the above-described basis keys (six excluding the base keyform), and the difference information D11 of KeyformIndex: [PARAM_X1.0, PARAM_Y0.5, PARAM_Z1.0], the keyform F7 can be derived by

F7=F0+D2+D3+D6+D7+D8+D9+D11.

Meanwhile, even in a case where state definition has not been performed for an arbitrary key, it is possible to obtain difference information that reflects state changes according to parameter values in parameter spaces of lower dimensions (of at least one dimension) from the keyform table. Accordingly, in the keyform editing application of the present embodiment, in a case where state definition has not been performed for an arbitrary key, state information derived by taking a sum total of the state information of the base key and the difference information of all of the basis keys is used as the keyform according to the arbitrary key. Specifically, if only state definition for the parameter keys that are set is performed for the one-dimensional parameter spaces formed for each of the plurality of types parameters, it is possible to derive difference information for a multi-dimensional parameter space formed compositively by these parameters.

Accordingly, in order to derive a keyform F7 of a not yet defined three-dimensional key which is identified by KeyformIndex: [PARAM_X1.0, PARAM_Y0.5, PARAM_Z1.0] in the example of FIG. 4, by using the state information F0 of the base keyform, and the difference information D2, D3, D6, D7, D8, and D9 of the above-described basis keys (six excluding the base keyform) the keyform F7 can be derived by

F7=F0+D2+D3+D6+D7+D8+D9.

Consequently, in the keyform editing application of the present embodiment, even if state definition has not be performed for a key falling under a multi-dimensional parameter space, it is possible to derive the keyform of the key from the state information and the difference information of the basis keys that fall under lower dimension parameter spaces. Consequently, difference information managed for a key falling under a multi-dimensional parameter space has meaning as a value for further adjusting a keyform of the key derived based on basis keys falling under lower dimension parameter spaces in this way. Specifically, in rough modeling at an initial stage where a character, for example, is produced, if a user defines a keyform (for a one-dimensional key) of a rendering object for each parameter key arranged for each parameter, keyforms in other parameter key sets are generated derivationally. Also, for a generated arbitrary key of a parameter key set, in a case where an adjustment for approaching a more desired shape is performed, since only difference information that is tacked on to the difference information according to the basis keys is managed for that arbitrary key of the parameter key set, it is possible to update the keyform list without affecting keyforms according to keys of lower dimensions. Such a function for simplifying a calculation and guaranteeing editing freedom is brought about by a configuration that holds differences, from the base keyform, of a keyform according to an arbitrary parameter key set, separating into keys of corresponding parameter spaces, and can contribute to a reduction in user workload.

Also, in a keyform editing application of the present embodiment, in a case where parameter keys and a combination of parameter values including different values (a parameter value set) are set based on information of various keyforms defined for a rendering object, state information corresponding to that parameter value set is derived by an interpolation calculation, and a rendering object of a form according to that state information is presented on the form composite palette 203. Specifically, upon a user causing a three-dimensional rendering expression of a rendering object to be presented, by defining keyforms of the rendering object for the plurality of types of keys (parameter key set), it is possible to cause a state of the rendering object between keys to be generated by interpolation in accordance with parameter values. As described above, since difference information of keys for which a keyform is defined is managed, by the keyform table of the present embodiment, by separating into parameter spaces of different dimensions, it is possible to adaptively decide a parameter space necessary for an interpolation calculation for state information in accordance with a parameter value set for which rendering expression presentation is required. By this, it is possible to reduce unnecessary calculations and the number of memory accesses for referencing stored values and reduce the calculation load.

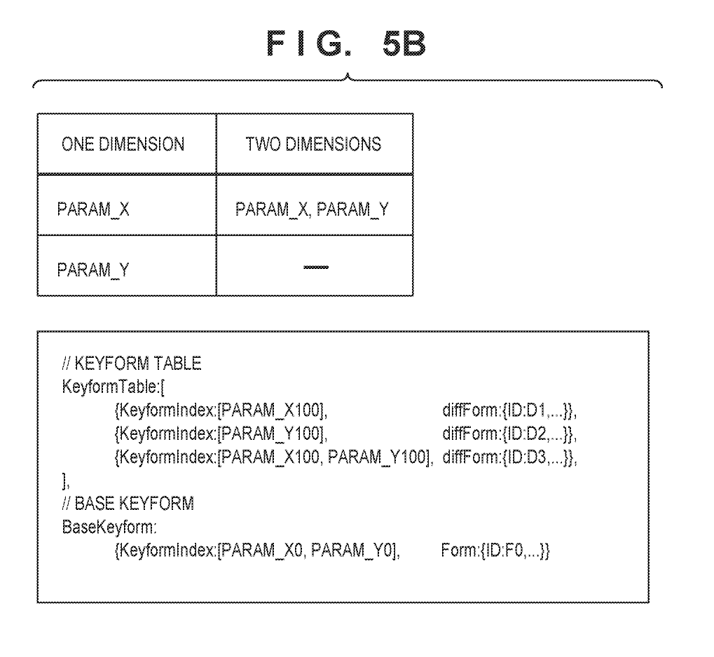

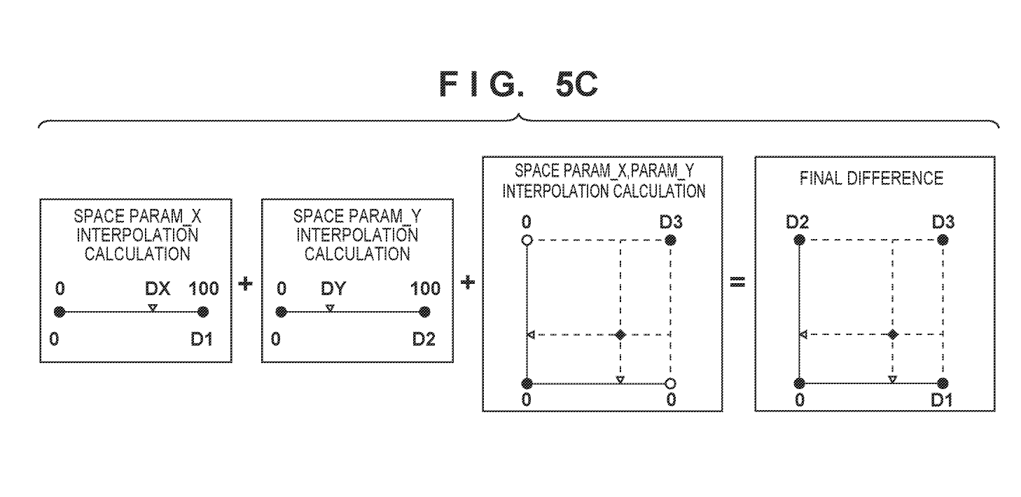

For example, an interpolation calculation when deriving a keyform according to a parameter value set (PARAM_X=DX, PARAM_Y=DY) of in a two-dimensional parameter space (PARAM_X, PARAM_Y) as illustrated in FIG. 5A can be derived by taking a sum total of interpolation calculations for the two types of one-dimensional keys in the one-dimensional parameter spaces ((PARAM_X), (PARAM_Y)) as illustrated in FIG. 5C and an interpolation calculation of the one type of two-dimensional key in the two-dimensional parameter space, in a case where the parameter table, the keyform table, and the base keyform are as in FIG. 5B. More specifically, in a case where dx indicates a ratio of the parameter value PARAM_X=DX with respect to the base key when a section indicated by the base key and KeyformIndex:[PARAM_X100] is made to be 1 and dy indicates a ratio of the parameter value PARAM_Y=DY with respect to the base key when a section indicated by the base key and KeyformIndex:[PARAM_Y100] is made to be 1, the state information Form (PARAM_XDX, PARAM_YDY) corresponding to the parameter value set can be derived using the difference information D1 to D3 for the respective keyforms by

Form(PARAM_XDX, PARAM_YDY)

=F0(base keyform)

+dx*D1(interpolation calculation in one-dimensional parameter space(PARAM_X))

+dy*D2(interpolation calculation in one-dimensional parameter space(PARAM_Y))

+dx*dy*D3(interpolation calculation in two-dimensional parameter space(PARAM_X,PARAM_Y)).

Specifically, it is possible to derive state information of a rendering object of a desired parameter value set while reducing the state reference count in an interpolation calculation for each parameter space and reducing the scale of calculation. Here, since, in the example of FIG. 5, the keys that fall under a one-dimensional parameter space (specified by only one type of parameter key) do not fall under the two-dimensional parameter space, in the interpolation calculation for the two-dimensional parameter space, difference information of a the corresponding key is treated as “no difference” (0), and as a result, all that is left as the calculation result is an item for which a two-dimensional weighting is performed for the difference information D3 of the two-dimensional key.

Consequently, if the number of types of parameters is n, rather than performing an interpolation calculation involving 2″ state references, as in the technique described in Japanese Patent Laid-Open No. 2009-104570, it is possible to perform the interpolation calculation at a minimum scale in accordance with whether or not there is relatedness between the parameters and whether or not keyforms are defined. Accordingly, by virtue of the keyform editing application of the present embodiment, it is possible for a user to set more types of parameters in proportion to the calculation load according to display of the rendering object being reduced, and so easy definition of desired rendering object states is facilitated without using a curved surface for which there is the possibility that a suitable rendering expression will not be attained. In other words, finer (more) keyform setting becomes possible by taking a data management configuration such as the parameter table and the keyform table of the present embodiment, and keyforms of states that the user intends become easier to define. This makes it easier, in a form in which a rendering object to be used in a display is switched to something else in accordance with a viewing direction, for example, as described above, to arrange shapes, colors, and the like of a rendering object in the proximity of a boundary of a switch.

<Presentation of Rendering Object>

Also, regarding presentation of a rendering object in accordance with state definition performed in the keyform editing application of the present embodiment, the data configuration for referencing differs between display during (1) editing work in that application as described above and (2) display in an external application, viewer, or the like (display of data that is outputted, after completion of editing in the keyform editing application, so as to be usable in an external application), where there is a requirement that calculation load be suppressed and responsiveness be high.

<Display During Editing>

Display of a rendering object during editing is performed by deriving difference information added in relation to the base keyform while maintaining the configurations of the parameter table and the keyform table, considering addition of new keys and modification of keyforms that are already defined while confirming state changes of a rendering object generated by interpolation in conjunction with parameter value set modification. More specifically, a parameter space including parameter values that are set (in a case where there are n types of parameters for which values other than the reference value are set, a range of values stipulated by 2×n keys that contains the parameter values) is specified, difference information according to the parameter values is accumulated by a weighting calculation in order from the lowest dimension parameter space to the highest dimension parameter space, final difference information is added to the base keyform, and thereby the state of the rendering object to be displayed is derived.

Note that in the keyform editing application, since configuration is such that the state of the rendering object for a multi-dimensional parameter space is derived by difference information accumulation, when a modification of a keyform in a lower dimension parameter space is applied, the effect of the modification spreads to higher dimension parameter spaces. Such a spread of the effect of a modification, in a case where the definition of a keyform of a higher dimension parameter space was suitable, for example, may be disruptive. Accordingly, in the keyform editing application, there is a “pinning” function for avoiding the effect on a corresponding key of a higher dimension (derivation key) that is not wished to be modified when editing an arbitrary key, and a configuration for cancelling out the effect of a keyform modification in a lower dimension parameter space is arranged thereby. More specifically, regarding a key for which state definition has bee performed, for example, logical type information which indicates whether or not to execute the pinning function (cancel out the effect of a keyform modification in a lower dimension parameter space; in other words, maintain a defined keyform that is independent of keyform modification in a lower dimension parameter space) is stored and managed in the memory 103.

Information in accordance with execution of the pinning function (pinning flag) may be something that is set to true (execute) by the user selecting a key to which application is desired in the keyform list 205 of FIG. 2, for example. Note that the pinning flag 206 as in the figure may be settable for a key for which state definition has not been performed. Specifically, for an arbitrary key, configuration may by such that it is possible to set a pinning flag, in a case where state information derived by a sum total of difference information of basis keys of that arbitrary key is suitable, so as to maintain this (not be influenced by keyform editing/definition in a lower dimension parameter space) even when definition of a keyform has not been performed for that arbitrary key. In such a case, if a keyform modification whose effect could spread to that arbitrary key is performed, difference information (difference information for eliminating the modification) for causing the state information of that arbitrary key to be maintained may be added to the keyform table, and modification into a state for which state definition has been performed may be performed.

<Display During Runtime>

Meanwhile, in display of a rendering object during runtime after editing completion, in order to reduce the number of times that a weighting calculation is performed (number of parameter spaces) and the number of keys that are referenced in a weighting calculation, parameter spaces that are being managed by separating by dimensions in the parameter table during editing are integrated as much as possible. Specifically, unlike when editing where ease of editing is being considered, it is not necessary to allow modification of difference information during runtime. Accordingly, such that the parameter table be configured by only mutually exclusive parameter spaces, in a case where there is a corresponding higher dimension parameter space, lower dimension keys are converted into higher dimension keys, and the key difference information that was present is updated in the higher dimension parameter spaces so that difference information is maintained, to thereby generate a parameter table and a keyform table for output.

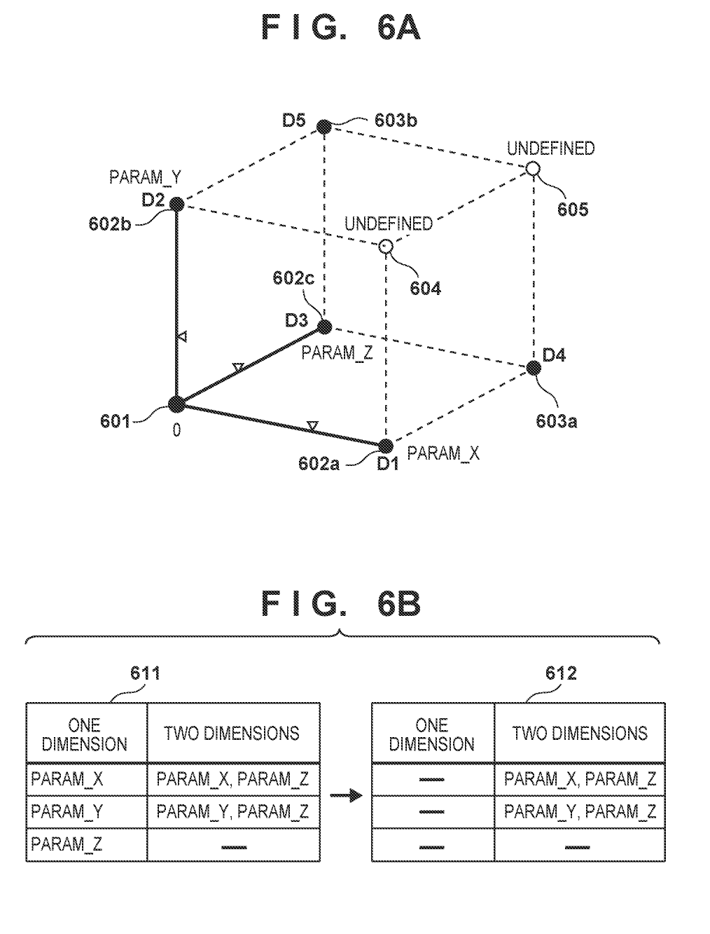

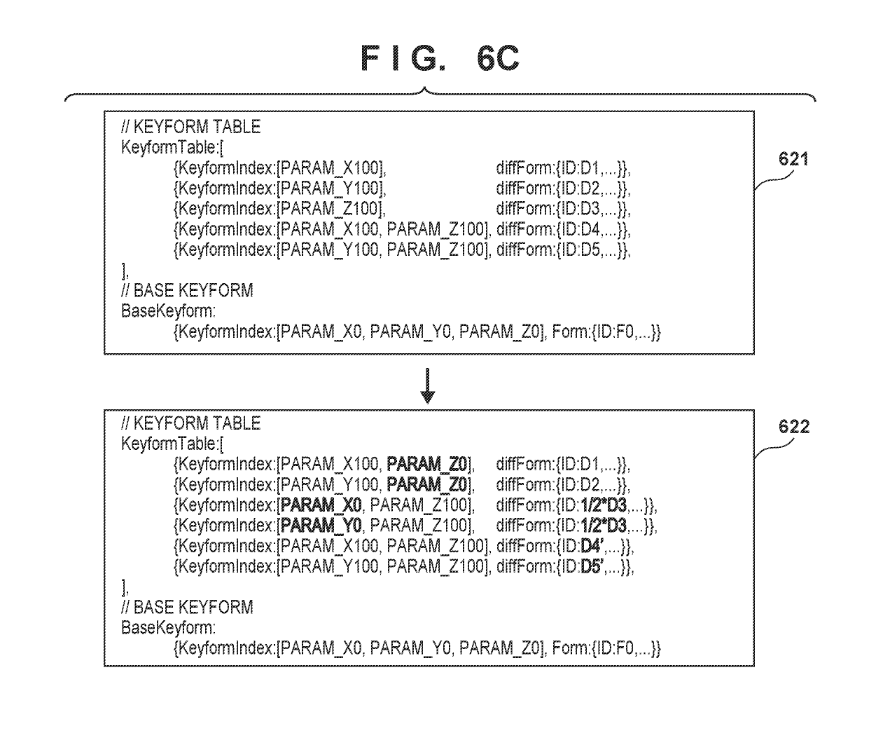

For example, in a case where three type of parameters (PARAM_X, PARAM_Y, and PARAM_Z) are associated with a rendering object, state definition has been performed for keys indicated by black points in the parameter space of FIG. 6A (base key 601, one-dimensional keys 602a-c, and two-dimensional keys 603a-b), and state definition has not been performed for keys indicated by white points (two-dimensional key 604 and three-dimensional key 605), the parameter table and the keyform table for output are as follows.

In the example of FIG. 6A, since state definition has not been performed for the three-dimensional parameter space (three-dimensional key 605), in the parameter table 611 held during editing, as illustrated in FIG. 6B, no three-dimensional parameter space is included, and one-dimensional parameter spaces ((PARAM_X), (PARAM_Y), (PARAM_Z)) and two-dimensional parameter spaces ((PARAM_X, PARAM_Z), (PARAM_Y, PARAM_Z)) are being managed. In other words, the state in which state definition has not been performed for the three-dimensional key 605 means that the managed two-dimensional parameter spaces can be treated as an exclusive spaces. Here, exclusive parameter spaces means spaces for which interpolation calculations for the respective parameter spaces can be separated without the necessity of performing a collective interpolation calculation (in accordance with the number of dimensions of the parameter value set) when deriving state information for a parameter value set according to a higher dimension parameter space. Specifically, when deriving state information for a parameter value set according to a three-dimensional parameter space according to FIG. 6A, it is possible to discriminate that it is a space for which it is possible to reduce the processing load in accordance with interpolation calculation (state reference count in interpolation calculation is reduced from 2³→2²).

Meanwhile, regarding the two-dimensional parameter spaces ((PARAM_X, PARAM_Z), (PARAM_Y, PARAM_Z)) for which state definition has been performed, it is possible to integrate the one-dimension parameter space according to parameters that form these parameter spaces respectively into two-dimensional parameter spaces. Specifically, since the keys for which a state reference is performed in an interpolation calculation for a two-dimensional parameter space are the keys for which a state reference is performed in an interpolation calculation for each one-dimensional parameter space as well, by integrating the parameter spaces, the number of times that the interpolation calculation is performed can be reduced (omission of three interpolation calculations according to the one-dimensional parameter spaces), and overlap of the number of state references in interpolation calculation performed overall can be reduced. Accordingly, the parameter table 612 for output is configured only by two types of two-dimensional parameter spaces as illustrated in FIG. 6B.

Also, as illustrated in FIG. 6C, in order to apply parameter space integration in conformity with the parameter table in a case where the keyform table 621 which is held when editing is configured, for keys falling under one-dimensional parameter spaces, the keyform indexes are modified to accord to the parameter spaces after the integration (according to the parameter spaces after integration, the missing parameter key is compensated for with a reference value).

Here, since both of the two types of parameter spaces are integration results for the key indicated by KeyformIndex: [PARAM_Z100] falling under the one-dimensional parameter space (PARAM_Z), it results in two types of keyform indexes (KeyformIndex: [PARAM_X0, PARAM_Z100], KeyformIndex: [PARAM_Y0, PARAM_Z100]) modified for these spaces respectively. However, since an interpolation calculation is performed exclusively for the two types of two-dimensional parameter spaces ((PARAM_X, PARAM_Z), (PARAM_Y, PARAM_Z)), referencing of the key KeyformIndex: [PARAM_Z100] is performed overlappingly in the case where these calculation results are integrated, and the weighting on the difference information D3 according to that key becomes double. Accordingly, in the keyform table 622 for output, for such keys for which referencing will overlap in a plurality of exclusive parameter spaces, the difference information is converted to values divided equally in accordance with the number of parameter spaces of a higher number of dimensions after the integration.

Also, in a case of performing this kind of parameter space integration, the method for deriving state information is changed from a form in which state information of a desired parameter value set is derived by taking a sum total of results of interpolation calculation in each dimension parameter space as at the time of editing. Specifically, in the case where keys that fall under a lower dimension (one dimension) parameter space are converted by integration into keys that fall under parameter spaces of the same dimension (two dimensions), the keys (KeyformIndex: [PARAM_X100, PARAM_Z100], KeyformIndex: [PARAM_Y100, PARAM_Z100]), in the integration results, that originally fell under two-dimensional parameter spaces must be converted to difference information that includes the difference that was separated into the one-dimensional parameter spaces at the time of editing. Accordingly, regarding the two-dimensional key difference information D4′ and D5′ for these illustrated in FIG. 6C, considering the difference information after equal division for the overlapping keys, the conversions are

D4′=D1+1/2*D3+D4 and

D5′=D2+1/2*D3+D5.

Thereby, whereas, in the form of FIG. 6A, for derivation of state information for a parameter value set in a two-dimensional parameter space, during editing, 5 interpolation calculations: interpolation calculations ×3 ((PARAM_X), (PARAM_Y), (PARAM_Z)) for one-dimensional parameter spaces, interpolation calculations ×2 ((PARAM_X, PARAM_Z), (PARAM_Y, PARAM_Z)) for two-dimensional parameter spaces and sum total calculation for these were required, by the conversion for output, only interpolation calculations ×2 ((PARAM_X, PARAM_Z), (PARAM_Y, PARAM_Z)) for the two-dimensional parameter spaces and the sum total calculation for these are performed, and so it is possible to reduce the calculation scale. Also, from the perspective of the number of state references for each interpolation calculation, while it is 2×3+2²×2=14 during editing, it becomes 2²×2=8 by the conversion for output, and so it is possible to reduce the number of memory accesses.

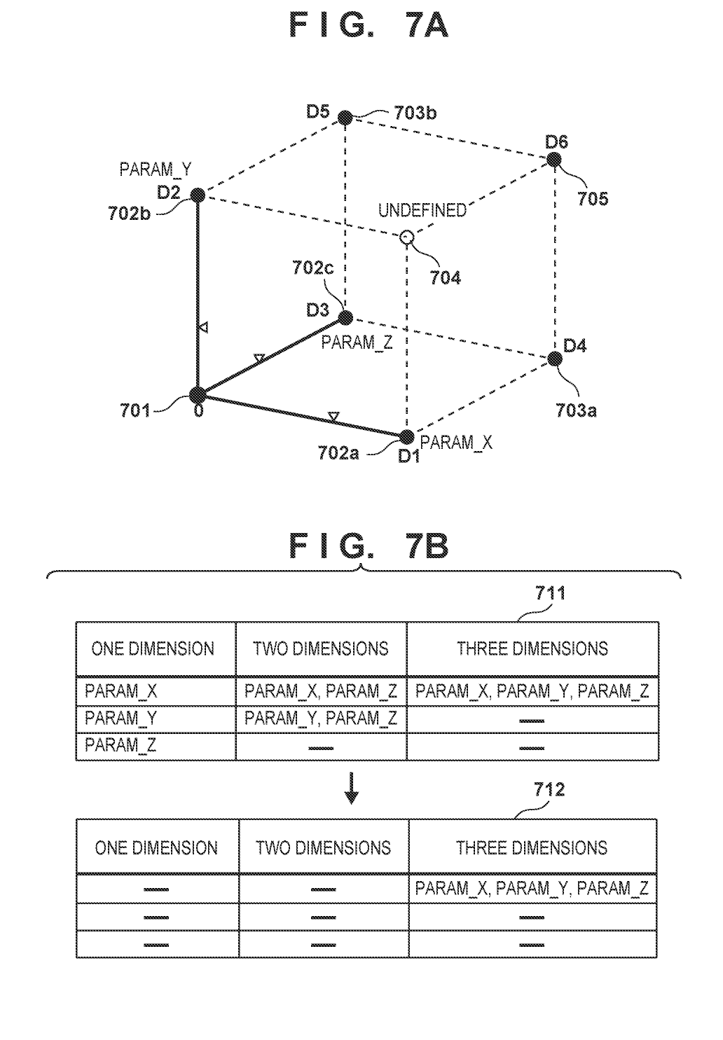

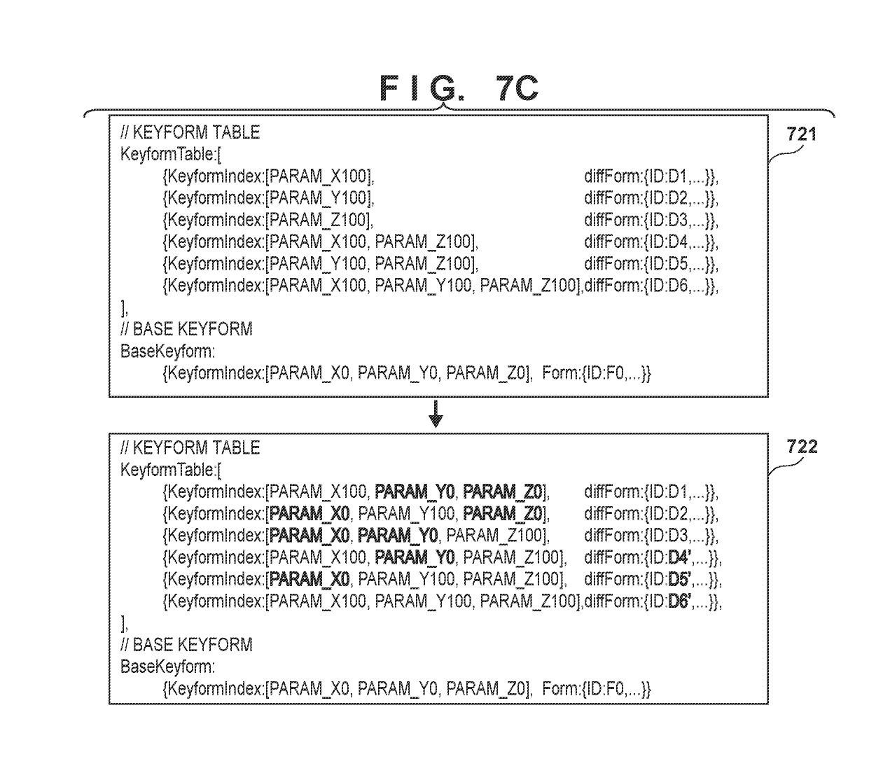

Also, for example, in a case where three type of parameters (PARAM_X, PARAM_Y, and PARAM_Z) are associated with a rendering object, state definition is performed for keys indicated by black points in the parameter space of FIG. 7A (base key 701, one-dimensional keys 702a-c, and two-dimensional keys 703a-b, and the three-dimensional key 705), and state definition has not been performed for keys indicated by white points (two-dimensional key 704), the parameter table and the keyform table for output are as follows.

In the example of FIG. 7A, since state definition has been performed for the three-dimensional parameter space (three-dimensional key 705), in the parameter table 711 held during editing, as illustrated in FIG. 7B, one-dimensional parameter spaces ((PARAM_X), (PARAM_Y), (PARAM_Z)) two-dimensional parameter spaces ((PARAM_X, PARAM_Z), (PARAM_Y, PARAM_Z)), and a three-dimensional parameter space ((PARAM_X, PARAM_Y, PARAM_Z)) are managed. Accordingly, in relation to the three-dimensional parameter space for which state definition has been performed, it is possible to integrate for the one-dimensional parameter spaces and two-dimensional parameter spaces according to the parameters that form that parameter space. Accordingly, the parameter table 712 for output is configured only by one type of three-dimensional parameter space as illustrated in FIG. 7B.

Also, as illustrated in FIG. 7C, in order to apply parameter space integration in conformity with the parameter table in a case where the keyform table 721 held when editing is configured, for keys falling under one-dimensional parameter spaces and keys falling under two-dimensional parameter spaces, the keyform indexes are modified to accord to the (three-dimensional) parameter space after the integration (according to the parameter space after integration, the missing parameter keys are compensated for with reference values).

Here, the integration of parameter spaces is performed in order from highest to lowest dimension, and since there is only one three-dimensional parameter space, division of difference information according to the plural existence in parameter spaces in the integration result is not performed, unlike in the form illustrated in FIG. 6. Consequently, regarding the difference information D4′, D5′, and D6′ for three-dimensional keys illustrated in FIG. 7C, by simply accumulating the difference information of the lower dimension parameter spaces,

D4′=D1+D3+D4,

D5′=D2+D3+D5, and

D6′=D1+D2+D3+D4+D5+D6.

Thereby, whereas, in the form of FIG. 7A, for derivation of state information for a parameter value set in a three-dimensional parameter space, during editing, 6 interpolation calculations: interpolation calculations ×3 ((PARAM_X), (PARAM_Y), (PARAM_Z)) for one-dimensional parameter spaces, interpolation calculations ×2 ((PARAM_X, PARAM_Z), (PARAM_Y, PARAM_Z)) for two-dimensional parameter spaces, interpolation calculations ×1 ((PARAM_X, PARAM_Y, PARAM_Z)) for the three-dimensional parameter space and sum total calculation for these were required, by the conversion for output, only interpolation calculation ×1 ((PARAM_X, PARAM_Y, PARAM_Z)) for the three-dimensional parameter space is performed, and so it is possible to reduce the calculation scale. Also, from the perspective of the number of state references for each interpolation calculation, while it is 2×3+2²×2+2³×1=22 during editing, it becomes 2³×1=8 by the conversion for output, and so it is possible to reduce the number of memory accesses.

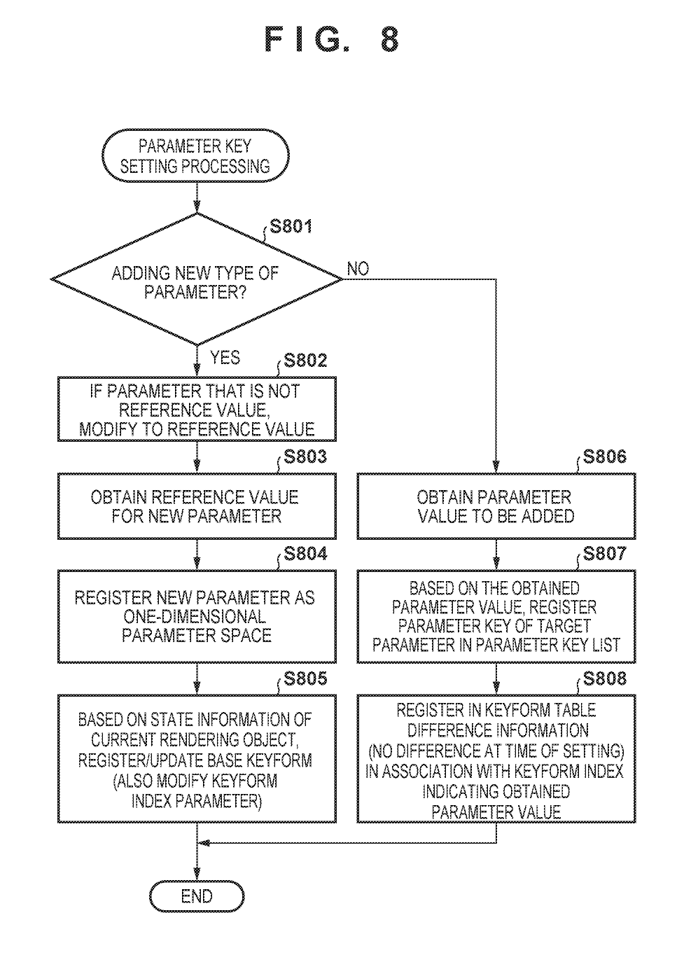

Hereinafter, for each type of process performed in the keyform editing application of the present embodiment, detailed processing will be described with reference to the flowchart of FIGS. 8-12 and 14. The processing corresponding to these flowcharts can be realized by the control unit 101 reading a corresponding processing program stored in the storage medium 102, for example, loading it into the memory 103, and executing it.

<Parameter Key Setting Processing>

First, description will be given using the flowchart of FIG. 8 for parameter key setting processing that is executed in a case where in relation to a rendering object, a parameter according to a one-dimensional parameter space is associated or setting (adding) of a parameter key to a corresponding parameter is performed. Note that this parameter key setting processing is described as being something that is started when operation input according to a request to associate a new type of parameter or a request to add a parameter key to an already associated parameter being made in relation to the parameter palette 201 of the keyform editing application is detected.

In step S801, the parameter definition unit 104 determines whether or not the detected request is an association request for adding a new type of parameter to the parameters that are associated with the rendering object. The parameter definition unit 104, moves the processing to step S802 in a case where it determines that the detected request is an association request for adding a new type of parameter, and moves the processing to step S806 in a case where it determines that it is not an association request; specifically, it is a parameter key addition request.

In step S802, if there is something for which a parameter value that is not a reference value has been set for an already associated parameter, the parameter definition unit 104 modifies the parameter value of that parameter to a reference value.

In step S803, the parameter definition unit 104 obtains the reference value (one parameter key) for the newly associated parameter. For the reference value, a value inputted by a user may be obtained, or a value that is defined by default may be obtained.

In step S804, the parameter definition unit 104 registers, as a one-dimensional parameter space, the parameter for which the association request was made, and updates the parameter table.

In step S805, the state definition unit 105 registers or updates the base keyform, based on the state information of the current rendering object. At that time, even in the case where base keyform information is already stored, the state definition unit 105 modifies the configuration of the keyform index of the base keyform to include the parameter key (reference value) of the newly associated parameter.

Meanwhile, in step S801, in a case where the detected request is determined not to be an association request for adding a new type of parameter, the parameter definition unit 104, in step S806, obtains a parameter value of the parameter key to be added. For the parameter value, a numerical value inputted by a user may be obtained, or a numerical value corresponding to a coordinate on a slider at which instruction input was performed may be obtained.

In step S807, the parameter definition unit 104, based on the value obtained in step S806, registers the parameter key for the target parameter in the parameter key list. In a case where there is a multi-dimensional parameter space formed to include the target parameter at that time, the control unit 101 may generate keyform indexes that include the registered parameter key, and add them to the keyform list.

In step S808, the state definition unit 105 associates difference information indicating that there is no difference from the base keyform in the keyform index for the one-dimensional key that indicates the value obtained in step S806, and registers it by adding it to the keyform table. Specifically, when adding a new parameter key, since a keyform definition has not yet been performed for that parameter key, difference information that indicates that there is no difference is provisionally stored.

Thereby, the user can easily perform association of a desired parameter in relation to a rendering object and setting of a parameter key for a parameter.

<Keyform Editing Processing>

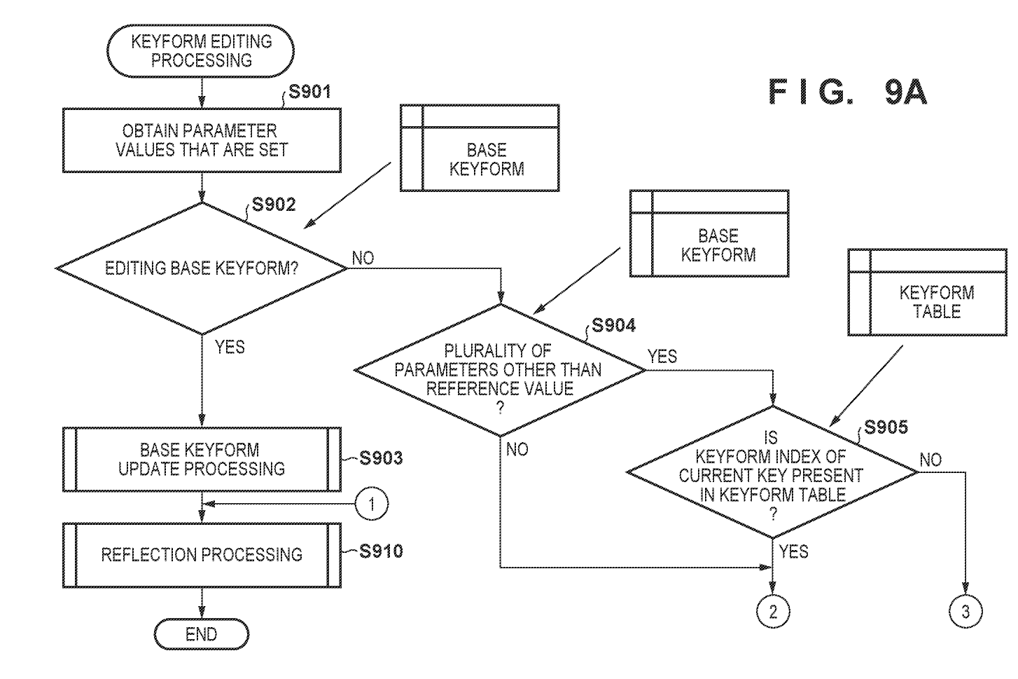

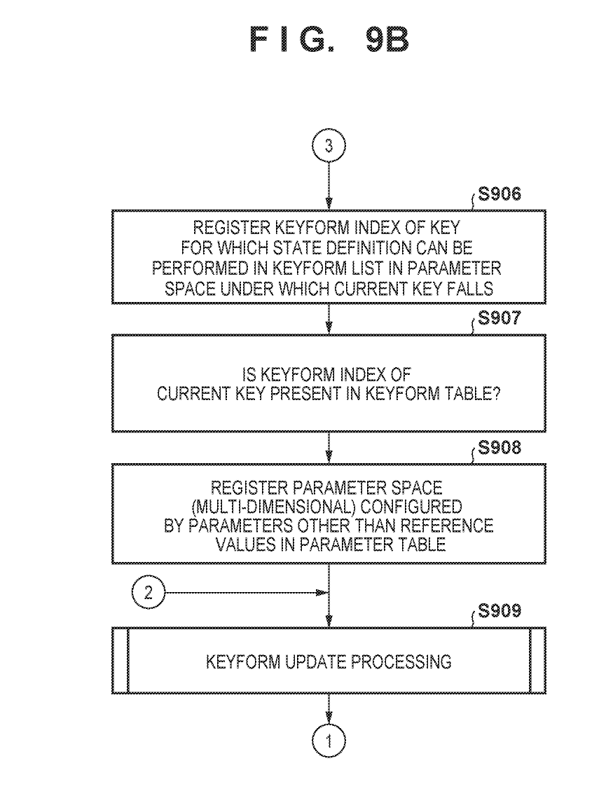

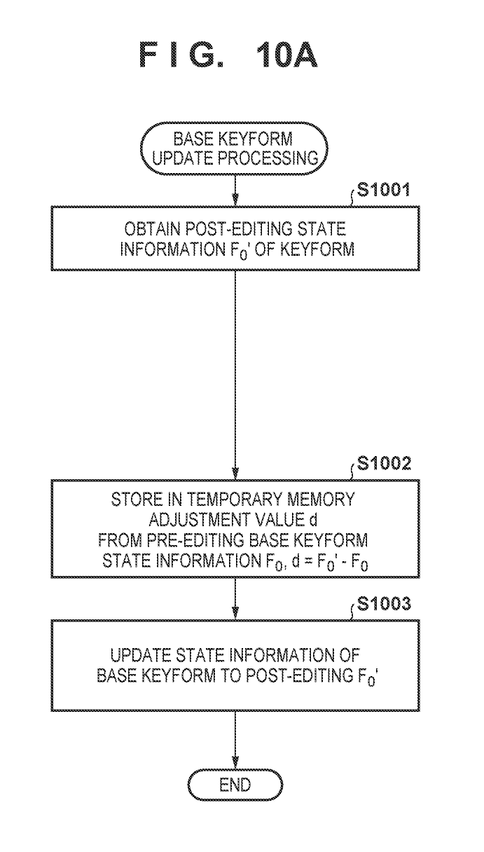

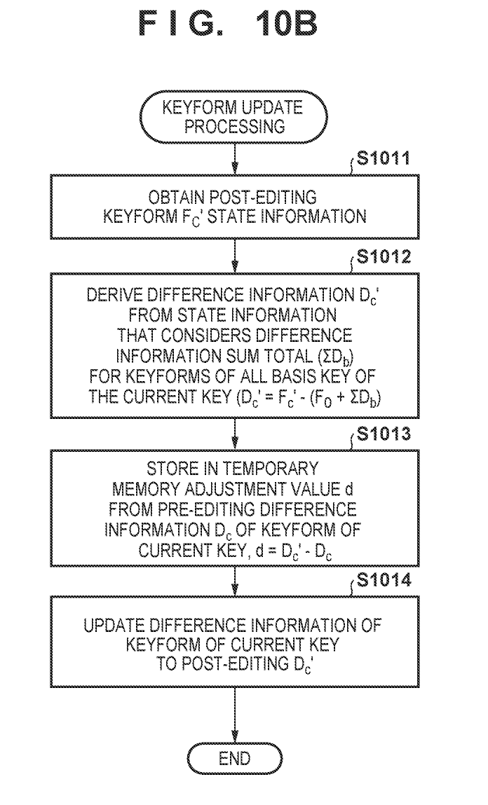

Next, description is given using the flowcharts of FIGS. 9A and 9B for keyform editing processing which is executed in a case where rendering object editing is performed in order to perform a keyform definition for a key that is specified by a combination of one or more parameter keys after the parameter keys have been set. Note that this keyform editing processing is described as something that is started when it is detected that an operation input for editing (modifying) a state of a rendering object of the viewport 202 was performed in a state in which an arbitrary parameter key set is set in the parameter palette 201 of the keyform editing application.

Here, it is assumed that, to avoid execution of processing for modifying the configurations of the parameter key list and the keyform list and complicating interpolation calculation, keyform definition/editing is not something that is recognized for a combination of arbitrary parameter values, but rather is only recognized for a parameter key combination. Consequently, while a combination of parameter values for which a parameter key is not set is being set, control may be performed such that rendering object state editing is not performed.

In step S901, the control unit 101 obtains the parameter values (parameter key set) that are currently set. The parameter values that are currently set are the parameter values that are set for all of the parameters associated with the rendering object, and it is assumed to be a parameter key set configured by a combination of any parameter value (including the reference value) set as a parameter key in a case where keyform definition is performed.

In step S902, the control unit 101 determines whether or not a keyform that is currently being edited is a base keyform. The determination of this step may be performed by, for example, comparing each parameter value of the parameters that configure the parameter key set that is currently set and the parameter values that configure the keyform index of the base keyform. The control unit 101 moves the processing to step S903 in a case where the keyform that is being edited is determined to be the base keyform, and moves the processing to step S904 in a case where it is determined to not be the base keyform.

In step S903, the state definition unit 105 executes base keyform update processing for reflecting the base keyform editing result.

<Base Keyform Update Processing>

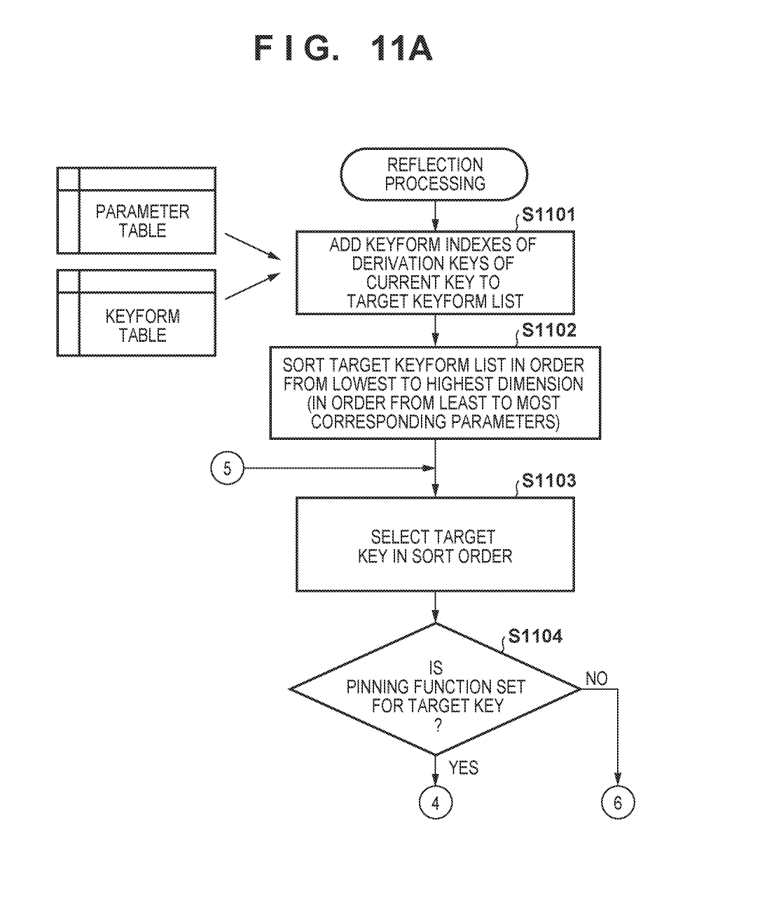

Here, description is given using the flowchart of FIG. 10A for base keyform update processing performed in this step.

In step S1001, the state definition unit 105 obtains post-editing state information F₀′ according to the base keyform. The information obtained in this step is something that defines absolutely a rendering form of the rendering object for which the editing is performed.

In step S1002, the state definition unit 105 derives an adjustment value d from the state information F₀ according to the pre-editing base keyform for the post-editing base keyform. Note that the adjustment value d that is derived in this step is a value that is used for deriving an effect that will spread to keyforms of derivation keys that accompanies the base keyform being modified, and may be stored in the memory 103.

In step S1003, the state definition unit 105 updates the state information according to the base keyform to the post-editing F₀′ and completes this base keyform update processing.

Meanwhile, in a case where, in step S902 of the keyform editing processing, it is determined that the keyform that is being edited is not a base keyform, the control unit 101, in step S904, determines based on the parameter key set that is currently set whether or not there are a plurality of parameters that indicate a parameter value other than a reference value. Specifically, in this step, it is discriminated whether keyform editing was performed for a key of a multi-dimensional parameter space or performed for a one-dimensional parameter space. The control unit 101 moves the processing to step S905 in a case where it determines that there are a plurality of parameters that indicate a parameter value other than a reference value, and moves the processing to step S909 in a case where it determines that there is only one type.

In step S905, the control unit 101 determines whether or not the keyform index of the current key (the key specified by the parameter key set that is currently set) is present in the keyform table. In the determination of this step, the parameter values other than a reference value of the parameter key set that is currently set are specified, and it is determined whether or not information that associates a keyform index configured by the combination of these parameter values other than the reference value is registered in the keyform table. Specifically, in this step, it is determined whether or not a parameter space under which the current key falls is already formed, in other words, whether or not there is a key for which a keyform definition was already performed for that parameter space. The control unit 101 moves the processing to step S909 in a case where a keyform index of the current key is determined to be present in the keyform table, and moves the processing to step S906 in a case where it is determined that none is present.

In step S906, the control unit 101 registers in the keyform list a keyform index of a key for which state definition can be performed for the parameter space under which the current key falls. As described above, a key for which a state definition is possible is a key that may fall under a multi-dimensional parameter space formed by a group of parameters other than reference values in a parameter key set that is currently set, and is a key for which a keyform index is defined by a combination of parameter keys (other than reference values) that are set for that group of parameters.

In step S907, the state definition unit 105 associates difference information indicating that there is no difference from the base keyform with the keyform index corresponding to the current key, and registers it by adding it to the keyform table. The difference information registered in this step is temporary information until the difference information according to the keyform that is being edited is registered in the later-described keyform update processing.

In step S908, the parameter definition unit 104, for the group of parameters other than reference values in the parameter key set currently being set, registers a parameter space formed by that parameter group in the parameter table, and updates the parameter table. For the parameter space that is registered in this step, the number of parameters other than a reference value in the parameter key set currently being set is made to be the number of dimensions.

In step S909, the state definition unit 105 executes keyform update processing for registering the edited keyform information.

<Keyform Update Processing>

Here, description is given using the flowchart of FIG. 10B for keyform update processing performed in this step.

In step S1011, the state definition unit 105 obtains post-editing state information F_{c}′ according to the base keyform. Similarly to step S1001 of the base keyform update processing, the information obtained in this step is something that defines absolutely the rendering form of the rendering object for which the editing was performed.

In step S1012, the state deriving unit 107 derives difference information D_{c}′ to be registered in the keyform table for the current key. More specifically, first, the space deciding unit 106, based on the parameter key set that is being set, the parameter table, and the keyform table, specifies all of basis keys for the current key. The state deriving unit 107 derives state information that summates a sum total ΣD_{b} for difference information of the keyforms of all of the basis keys of the current key and the state information F₀ of the base keyform. Then, the state deriving unit 107 derives difference information D_{c}′ according to the current key as a difference of the state information F_{c}′ according to the post-editing keyform from this derived state information.

In step S1013, the state definition unit 105 derives an adjustment value d from the difference information D_{c} according to the pre-editing keyform for the post-editing keyform. Note that the adjustment value d that is derived in this step is a value that is used for deriving an effect that will spread to keyforms of derivation keys that accompanies the keyform being modified, and may be stored in the memory 103.

In step S1014, the state definition unit 105 updates the difference information D_{c} according to the current key stored in the keyform table to the difference information D_{c}′ according to the post-editing keyform, and completes this keyform update processing. More specifically, the state definition unit 105 associates the difference information D_{c}′ according to the post-editing keyform with the keyform index corresponding to the current key, and updates the keyform table.

For the rendering object edited in this way, after the keyform table is updated by executing the base keyform update processing of step S903 or the keyform update processing of step S909 in the keyform editing processing, the state definition unit 105, in step S910, executes reflection processing for reflecting the effect to derivation keys according to this time's update.

<Reflection Processing>

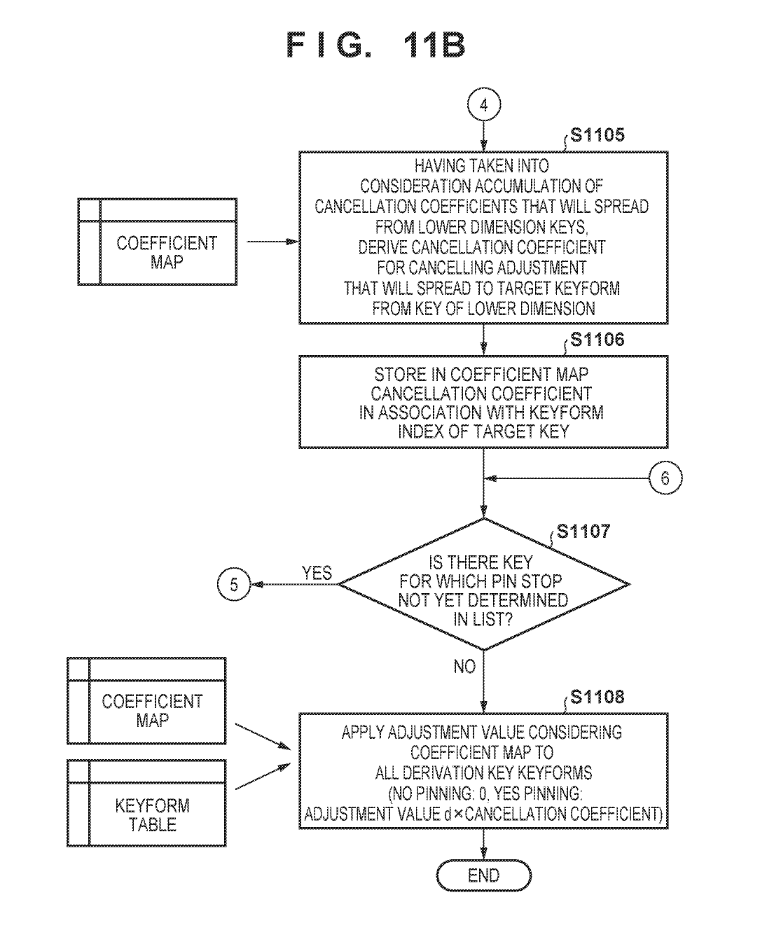

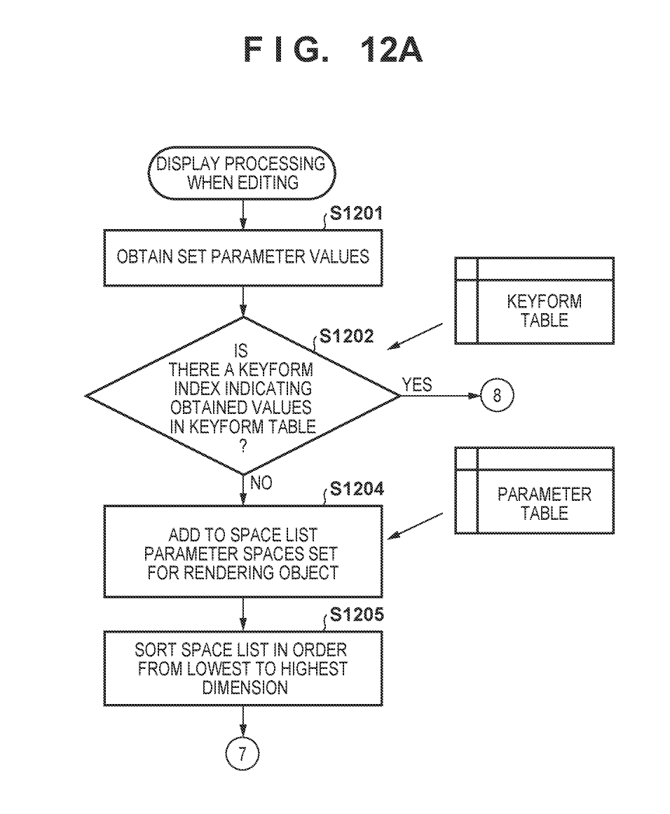

Here, description is given using the flowcharts of FIGS. 11A and 11B for reflection processing performed in this step.

In step S1101, the space deciding unit 106, based on the parameter key set that is currently set, the parameter table, and the keyform table, specifies all of the derivation keys for the current key. Then, the space deciding unit 106 adds the keyform indexes of the derivation keys that were specified to a target keyform list generated in the memory 103, for example.

In step S1102, the control unit 101 sorts the keyform indexes in the target keyform list in order from lowest to highest number of dimensions for the corresponding keys. Specifically, the control unit 101 sorts the keyform indexes of the target keyform list in order of least to most parameters configuring the keyform index.

In step S1103, the state definition unit 105 selects a keyform index that has not been selected yet in the sort order from the target keyform list. In loop processing from step S1103 to step S1107, a key identified by the keyform index selected in this step is processed as a target key.

In step S1104, the state definition unit 105 determines whether or not a pinning flag has been set for the target key. The state definition unit 105 moves the processing to step S1105 in a case where it is determined that a pinning flag has been set for the target key, and moves the processing to step S1107 in a case where it is determined that it has not been set.

In step S1105, the state definition unit 105, having taken into consideration accumulation of cancellation coefficients that will spread from lower dimension keys, derives a cancellation coefficient for cancelling adjustment that will spread to the keyform of the target key. As described above, in the keyform editing application of the present embodiment, the keyform of an arbitrary key is derived by adding difference information of basis keys of that arbitrary key in relation to the base keyform in order from lowest to highest dimension parameter space, and further adding the difference information of that arbitrary key. Accordingly, in a case where keyform editing is performed for an arbitrary key, that difference information modification amount (adjustment value) spreads to the derivation keys of that arbitrary key. Meanwhile, in a case where the pinning flag has been set for a derivation key, so as to make the state information of that derivation key the same as it was pre-editing, it is necessary to cancel the effect proportional to the adjustment value added when deriving that state information, by adjustment of the difference information of that derivation key. Accordingly, for a derivation key having a number of dimensions that is one more than that of the key for which the editing was performed, a value that multiplies the adjustment value by “−1” in relation to the difference information of that derivation key may be added in order to cancel an increase proportional to the adjustment value that is generated for the key for which editing was performed. At that time, “−1” is the cancellation coefficient for that derivation key.

Incidentally, the effect due to editing may spread to derivation keys of other parameter spaces of the same number of dimensions, and there may be derivation keys other than those of only one more dimension. Consequently, in this step, in case where, upon derivation of a cancellation coefficient after selection of a target key in order from the lowest to the highest number of dimensions from the target keyform list, a pinning flag has been set for the target key, cancellation coefficient derivation is performed recursively in order from lowest to highest number of dimensions, considering that the state information will change depending on the adjustment value and the cancellation coefficients defined for keys of a lower number of dimensions than that target key.

For example, in a case where editing is performed for a key of a one-dimensional parameter space ((PARAM_Z)), derivation keys exist in two-dimensional parameter spaces ((PARAM_X, PARAM_Z), (PARAM_Y, PARAM_Z)) and the three-dimensional parameter space ((PARAM_X, PARAM_Y, PARAM_Z)), and in a case where a pinning flag has been set for all the derivation keys, cancellation by a cancellation coefficient “−1” is performed for each derivation key of the two-dimensional parameter spaces. On the other hand, for the derivation key of the three-dimensional parameter space, adjustment from one-dimensional parameter spaces and two types of two-dimensional parameter spaces spreads in state information derivation. Specifically, for the derivation key of the three-dimensional parameter space, the adjustment value d, from a one-dimensional parameter space, and the adjustment value d multiplied by the cancellation coefficient “−1”, from each of the two types of two-dimensional parameter spaces, spread, and therefore, when summated, only

d+(−1)*d+(−1)*d=−d

can change from the pre-editing state information. Accordingly, the cancellation coefficient that is set for the derivation key of the three-dimensional parameter space is “+1”.

Also, for example, in a case where editing is performed for a key of a one-dimensional parameter space ((PARAM_Z)), derivation keys exist in two-dimensional parameter spaces ((PARAM_X, PARAM_Z), (PARAM_Y, PARAM_Z)) and the three-dimensional parameter space ((PARAM_X, PARAM_Y, PARAM_Z)), and in a case where a pinning flag has been set only for the derivation keys of the parameter spaces (PARAM_Y, PARAM_Z) and (PARAM_X, PARAM_Y, PARAM_Z) out of these, cancellation by a cancellation coefficient “−1” is performed for the derivation key of a two-dimensional parameter space ((PARAM_Y, PARAM_Z)). Also, a cancellation coefficient is not set for the derivation key of the two-dimensional parameter space ((PARAM_X, PARAM_Z)). On the other hand, for the derivation key of the three-dimensional parameter space, adjustment is spread from the one-dimensional parameter space and one type of two-dimensional parameter space in state information derivation. Specifically, for the derivation key of the three-dimensional parameter space, the adjustment value d, from the one-dimensional parameter space, and the adjustment value d multiplied by the cancellation coefficient “−1”, from the respective one type of two-dimensional parameter space, spread, and therefore, when summated,

d+(−1)*d=0,

and no change from the pre-editing state information arises. Accordingly, the cancellation coefficient that is set for the derivation key of the three-dimensional parameter space is “0”.

In step S1106, the state definition unit 105 stores the derived cancellation coefficient in association with the target key keyform index in a coefficient map stored in the memory 103, for example.

In step S1107, the state definition unit 105 determines whether or not there is a keyform index of a key for which it has not been determined whether or not there is a pinning flag in the target keyform list. The state definition unit 105 returns the processing to step S1103 in a case where it is determined that there is a keyform index of a key for which determination has yet to be performed, and moves the processing to step S1108 in a case where it is determined that none is present.

In step S1108, the state definition unit 105 applies an adjustment value to the difference information managed for all derivation keys included in the keyform table, based on the information of the cancellation coefficients stored in the coefficient map. At that time, for a derivation key for which a pinning flag has not been set, adjustment of difference information is not performed, and for a derivation key for which a pinning flag has been set, difference information adjustment is performed by a value resulting from multiplying the cancellation coefficient by the adjustment value.

In this way, by this keyform editing processing, it is possible to register in a keyform table editing that was performed in relation to a rendering object.

<Display Processing when Editing>

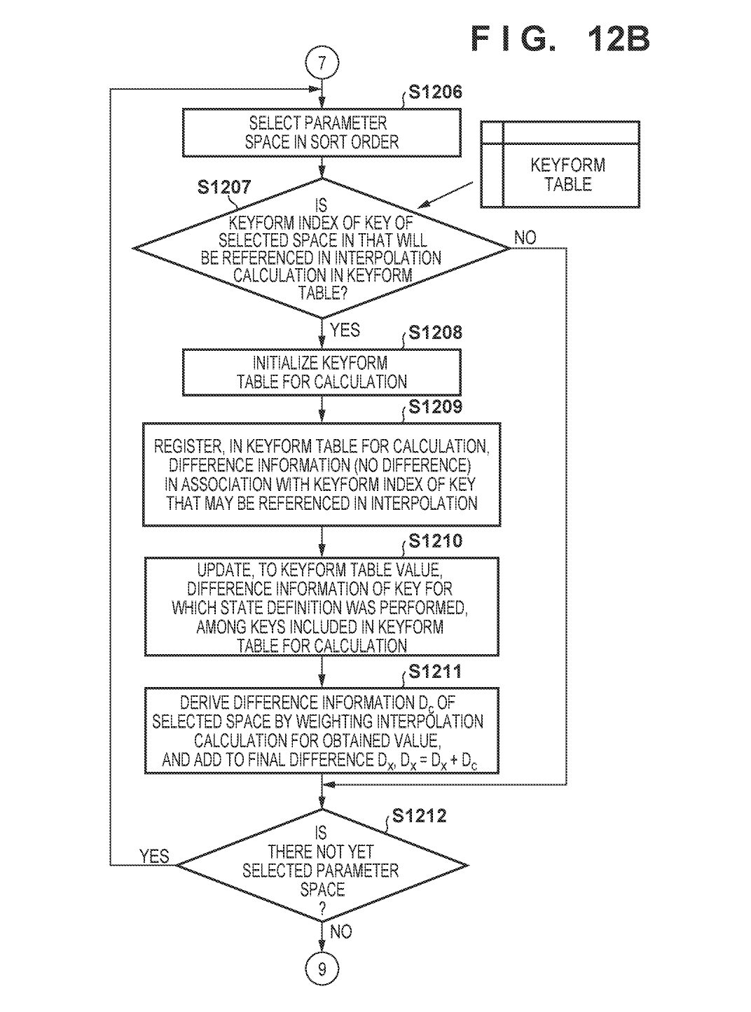

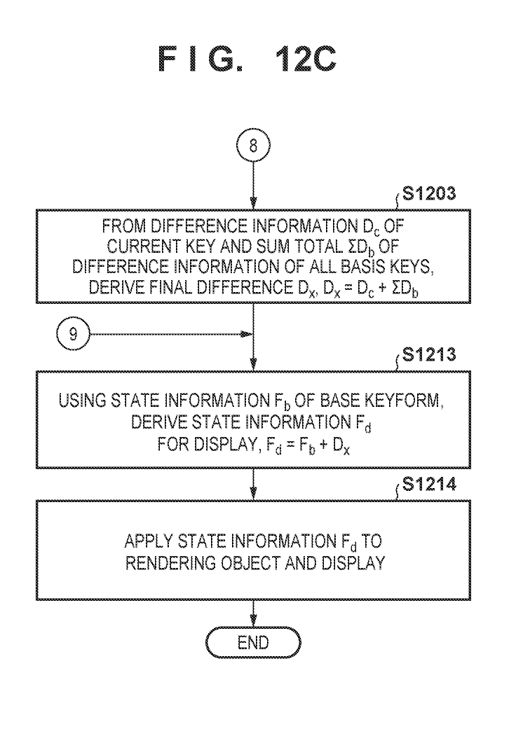

Next, description will be given using the flowcharts of FIGS. 12A, 12B and 12C for display processing when editing in which during a keyform editing, the rendering form of a rendering object is modified and caused to be displayed on the viewport 202. Note that this display processing when editing is described as being something that is started when it is detected that an operation input according to a modification of a parameter value was performed in the parameter palette 201 of the keyform editing application.

In step S1201, the control unit 101 obtains the parameter value set that is currently set. The parameter values that are currently set are the parameter values that are set for all of the parameters associated with the rendering object, and in a case where keyform definition is not performed, these may indicate any value of a numerical range defined for each parameter.

In step S1202, the control unit 101 determines whether or not there is a keyform index indicating the obtained parameter value set in the keyform table. Specifically, in this step, the control unit 101 determines whether or not the parameter value set that is currently set is a parameter key set for which state definition was performed. The control unit 101, in a case where it determines that there is a keyform index indicating the obtained parameter value set in the keyform table, moves the processing to step S1203, and in a case where it determines that one is not present, moves the processing to step S1204.

In step S1203, the state deriving unit 107 derives a difference Dₓ from the base keyform of the keyform corresponding to the parameter value set that is currently set. More specifically, first, the space deciding unit 106, based on the parameter value set that is currently set, the parameter table, and the keyform table, specifies all of basis keys for a key (current key) corresponding to that parameter value set. The state deriving unit 107 summates the difference information D_{c} being managed in a keyform table for the current key and a sum total ΣD_{b} of difference information for all basis keys of the current key, derives the final difference information Dₓ for display as

Dₓ=D_{c}+ΣD_{b},

and moves the processing to step S1213.

In a case where the keyform index that indicates the parameter value set obtained in step S1202 is determined to not be present in the keyform table, the space deciding unit 106, in step S1204, adds to a space list generated in the memory 103, for example, information of parameter spaces including at least one of the obtained parameter values among the parameter spaces set for the rendering object. Specifically, in this step, information of the parameter spaces for which an interpolation calculation is performed upon derivation of state information corresponding to the parameter value set is obtained.

In step S1205, the control unit 101 sorts the parameter spaces included in the space list in order from lowest to highest number of dimensions.

In step S1206, the state deriving unit 107 selects, in the sort order, a parameter space for which the interpolation calculation has not yet been executed which is included in the sorted space list. In the loop processing from step S1206 to step S1212, the parameter space selected in this step is processed as a selected space.

In step S1207, the state deriving unit 107 determines whether or not a keyform index of a key that falls under the selected space is present in the keyform table, where the keyform index will be referenced in the interpolation calculation for the selected space. In this step, first, it is determined whether a keyform is defined for a key that falls under the selected space, specifically, whether or not a keyform that is necessary for performing the interpolation calculation for that selected space is present. The state deriving unit 107 moves the processing to step S1208 in a case where a keyform index that falls under the selected space is determined to be present in the keyform table, and moves the processing to step S1212 in a case where it is determined that none is present.

In step S1208, the state deriving unit 107 defines a keyform table (keyform table for calculation) for the interpolation calculation in the memory 103, for example, and initializes it. Here, “initialize” means to allocate a region in which it is possible to hold information of keyforms of a number (2ⁿ) according to the number of dimensions (n) of the selected space.

In step S1209, the state deriving unit 107 registers in the keyform table for calculation difference information indicating no difference in association with a keyform index of a key that may be referenced in the interpolation calculation. Note that a key that may be referenced in the interpolation calculation is decided based on the parameter value set that is currently set, the parameters forming the selected space, and the keyform indexes of keys for which state definition has been performed in the selected space. The interpolation calculation, basically, for each of the parameters that form the selected space, is performed for a section that includes in a range a parameter value that is currently set for that parameter, and that is indicated by two parameter keys that indicate a value that is larger and a value that is smaller than that parameter value. Accordingly, a key that may be referenced in the interpolation calculation is a key, among the keys falling under the selected space, for which a keyform index has been configured by combination of a parameter key of an end point of the section defined for each parameter.

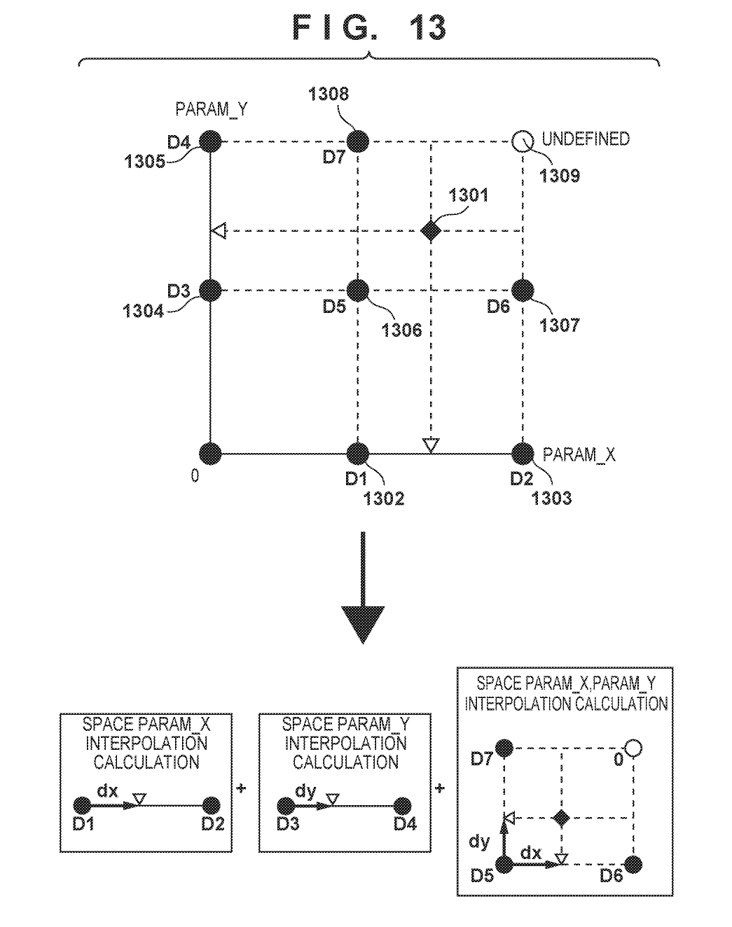

For example, as illustrated in FIG. 13, consider a case in which one-dimensional parameter spaces ((PARAM_X), (PARAM_Y)) and a two-dimensional parameter space ((PARAM_X, PARAM_Y)) are managed for a rendering object, a keyform is defined for keys indicated by black points, and a keyform is not yet defined for keys indicated by the white point, and the parameter value set ((PARAM_X, PARAM_Y)) that was currently set is a state 1301. At that time, in a case where the selected space is the one-dimensional parameter space ((PARAM_X)), keys 1302 and 1303, which correspond to parameter keys that include the parameter value of the PARAM_X component among the parameter value set that was currently set in a range, are the keys that may be referenced in the interpolation calculation. Similarly, in a case where the selected space is the one-dimensional parameter space ((PARAM_Y)), keys 1304 and 1305, which correspond to parameter keys that include the parameter value of the PARAM_Y component among the parameter value set that was currently set in a range, are the keys that may be referenced in the interpolation calculation. Also, in a case where the selected space is the two-dimensional parameter space ((PARAM_X, PARAM_Y)), since, for each component, two parameter keys that include the parameter value that is currently set in a range are specified, the keys 1306 to 1309 by which the two components are specified by a combination of these parameter keys are the keys that may be referenced in the interpolation calculation.

In step S1210, the state deriving unit 107, for keys for which a state definition has been performed among the keys included in the keyform table for calculation, updates difference information of the keyform table for calculation by using difference information that is managed in the keyform table for these keys. In the example of FIG. 13, in a case in which the selected space is a two-dimensional parameter space, since keyforms have been defined for the keys 1306 to 1308, information of the keyform table for calculation is updated to difference information that is being managed for each key in the keyform table. Meanwhile, since a keyform for the key 1309 is not yet defined, the information of the keyform table for calculation is not updated, and the difference information indicating no difference is held as is.

In step S1211, the state deriving unit 107, based on information of keys included in the keyform table for calculation, performs the interpolation calculation according to the selected space for a state of the selected space corresponding to the parameter value set that is currently set, and derives the difference information D_{c} according to that state. Also, the state deriving unit 107 adds the derived difference information D_{c} to the final difference information Dₓ that indicates a difference from the state information according to the base keyform of the state information corresponding to the parameter value set that is currently set. Here, for the final difference information Dₓ, the initial value is 0, and it is completed by accumulating difference information that is derived in order from lowest to highest dimension parameter space in the loop processing of step S1206 to step S1212.

In the example of FIG. 13, first, for the one-dimensional parameter space ((PARAM_X)), the interpolation calculation according to a weighting calculation according to a parameter value of a PARAM_X component that is currently set,

D(x)=dx*D2+(1−dx)*D1

is performed, and for the next one-dimensional parameter space ((PARAM_Y)), the interpolation calculation according to a weighting calculation according to a parameter value of a PARAM_Y component that is currently being set,

D(y)=dx*D4+(1−dy)*D3

is performed, and finally for the two-dimensional parameter space ((PARAM_X, PARAM_Y)), the interpolation calculation according to a weighting calculation according to a parameter value of each component that is currently set,

D(xy)

=(1−dx)*(1−dy)*D5

+dx*(1−dy)*D6

+(1−dx)*dy*D7

+dx*dy*0

is performed, and as a result, the final difference information Dₓ is derived by

Dₓ=D(x)+D(y)+D(xy).

In step S1212, the state deriving unit 107 determines whether or not there is a parameter space that has not been selected yet in the sorted space list. The state deriving unit 107 returns the processing to step S1206 in a case where it determines that there is a parameter space that has not been selected yet in the space list, and moves the processing to step S1213 in a case where it is determined that none is present.

In step S1213, the state deriving unit 107, by adding the final difference information Dₓ to the state information F_{b} according to the base keyform, derives the state information F_{d} of a state that is displayed for the parameter value set that is currently set.

In step S1214, the rendering unit 108 applies the state information F_{d} to the rendering object, renders an image according to the viewport 202, and causes it to be displayed on the display unit 120.

In this way, by virtue of the display processing when editing of the present embodiment, parameter spaces necessary for an interpolation calculation is specified for a parameter value set for which a presentation request was made, and for each of the necessary parameter spaces, interpolation calculation that uses difference information that is being managed for a key falling under that parameter space is performed recursively, and thereby it is possible to derive state information according to the parameter value set for which the presentation request was made.

<Runtime Data Output Processing>

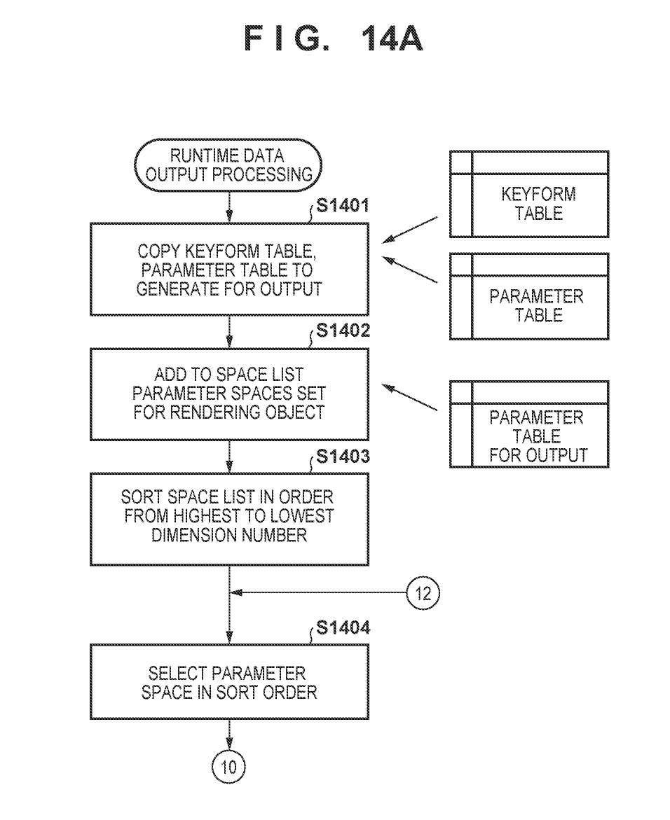

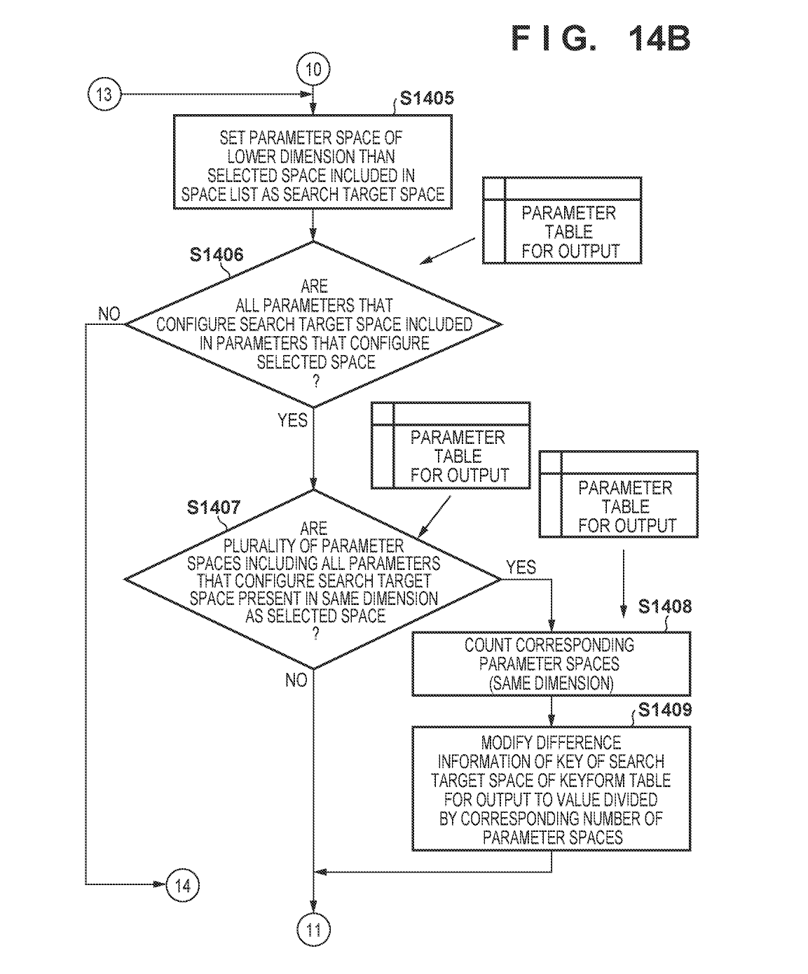

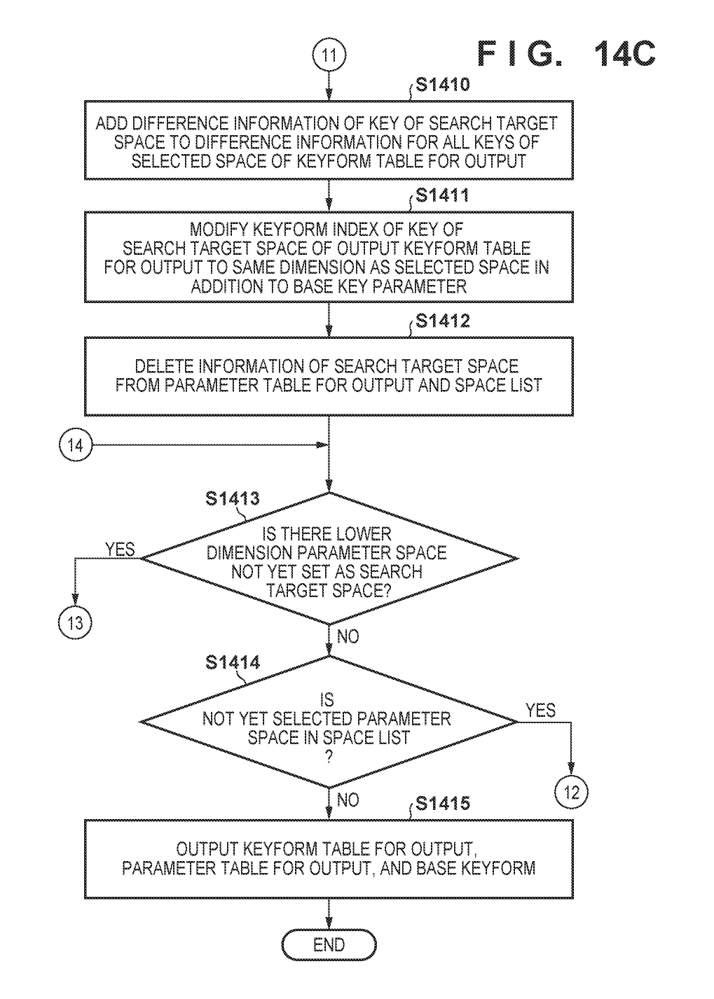

Next, runtime data output processing executed in a case where data output for runtime is performed (export) is described with reference to the flowcharts of FIGS. 14A, 14B and 14C. Note that this runtime data output processing is described as something that is started when it is detected that an operation input according to an export was performed in the keyform editing application.

Also, in the present embodiment, this runtime data output processing is described as something that is performed in the keyform editing application, but implementations of this processing are not limited to a form in which it is performed in an export in the keyform editing application which is for performing keyform definition and the like. For example, it may be executed in a case where data (the parameter table, the keyform table, and the base keyform of a state when editing) that is generated by the keyform editing application is inputted (imported) in an external application, a viewer, or the like.

In step S1401, the control unit 101 copies the keyform table and the parameter table to generate a keyform table for output and a parameter table for output, and stores them in the memory 103.

In step S1402, the control unit 101 adds information of the parameter spaces that are set for the rendering object to a space list generated in the memory 103, for example.

In step S1403, the control unit 101 sorts the parameter spaces included in the space list in order from highest to lowest number of dimensions.

In step S1404, the control unit 101 selects, in the sort order, a parameter space that is included in the sorted space list and for which loop processing for integration of step S1404 to step S1414 has not yet been executed. In the loop processing from step S1404 to step S1414, the parameter space selected in this step is processed as a selected space.

In step S1405, the control unit 101 sets, as a search target space, a parameter space of a number of dimensions lower than the selected space included in the space list and for which the loop processing for search of step S1405 to step S1413 has yet to be executed.

In step S1406, the control unit 101 determines whether or not all parameters that form the search target space are included in the parameters that form the selected space. The control unit 101 moves the processing to step S1407 in a case where it determines that all of the parameters that form the search target space are included in the parameters that form the selected space, and moves the processing to step S1413 in a case where it determines that they are not all included.

In step S1407, the control unit 101 determines whether or not a plurality of parameter spaces of the same dimension as the selected space and that include all parameters that form the search target space are present in the space list (including the selected space). The control unit 101 moves the processing to step S1408 in a case where it determines that a plurality of parameter spaces of the same dimension that include all of the parameters that form the search target space are present, and moves the processing to step S1410 in a case where it determines that there is no such parameter space other than the selected space.

In step S1408, the control unit 101 counts the number of parameter spaces of the same dimension that include all parameters that form the search target space that are included in the space list. Then, in step S1409, the control unit 101 modifies the value of the difference information of a key of the search target space of the keyform table for output to a value that is divided by the counted number of parameter spaces.

In step S1410, the control unit 101 adds difference information of a key that falls under the search target space to the difference information of all keys that fall under the selected space of the keyform table for output. Note that in a case where there are a plurality of parameter spaces of the same dimension that include all parameters that form the search target space, the control unit 101 adds the difference information of a key that falls under the selection target space to the difference information of all keys that fall under other parameter spaces of that same dimension.

In step S1411, the control unit 101 modifies the keyform index of a key that falls under the search target space of the keyform table for output to a keyform index of a parameter configuration of the same dimension as the selected space in addition to the parameters of the base key. Specifically, so that a key of a lower dimension that falls under the search target space is managed as a key of the same dimension as the selected space that falls under the selected space, the keyform index is adjusted in the keyform table for output. Note that in a case where there are a plurality of parameter spaces of the same dimension that include all parameters that form the search target space, the control unit 101 may copy a key that falls under the search target space to provide a number of parameter spaces of the same dimension, and modify them to keyform indexes of a parameter configuration that correspond to each of the parameter spaces.

In step S1412, the control unit 101 deletes information of the search target space from the parameter table for output and the space list. In this way, it is possible to convert information of the search target space into information of the selected space, and integrate in the parameter table for output and the keyform table for output.

In step S1413, the control unit 101 determines whether or not there is a parameter space that has not been selected yet as the search target space in parameter spaces of a lower number of dimensions than the selected space included in the space list. The control unit 101 moves the processing to step S1405 in a case where it determines that there is a parameter space that has not been selected yet in the search target space, and moves the processing to step S1414 in a case where it is determined that none is present.

In step S1414, the control unit 101 determines whether or not there is a parameter space that has not been selected yet as the selected space in the space list. At that time, parameter spaces that were integrated for a parameter space of a higher number of dimensions have already been deleted from the space list. The control unit 101 returns the processing to step S1404 in a case where it determines that there is a parameter space that has not been selected yet as the selected space, and moves the processing to step S1415 in a case where it is determined that none is present.

In step S1415, the control unit 101 outputs information of the keyform table for output, the parameter table for output, and the base keyform for which the processing has completed as data for runtime, and completes this runtime data output processing.

In this way, by this runtime data output processing, it is possible to convert the keyform table and the parameter table into a format that reduces the amount of information more than when editing, and reduces the number of interpolation calculations that are executed.

<Calculation Efficiency Comparison>

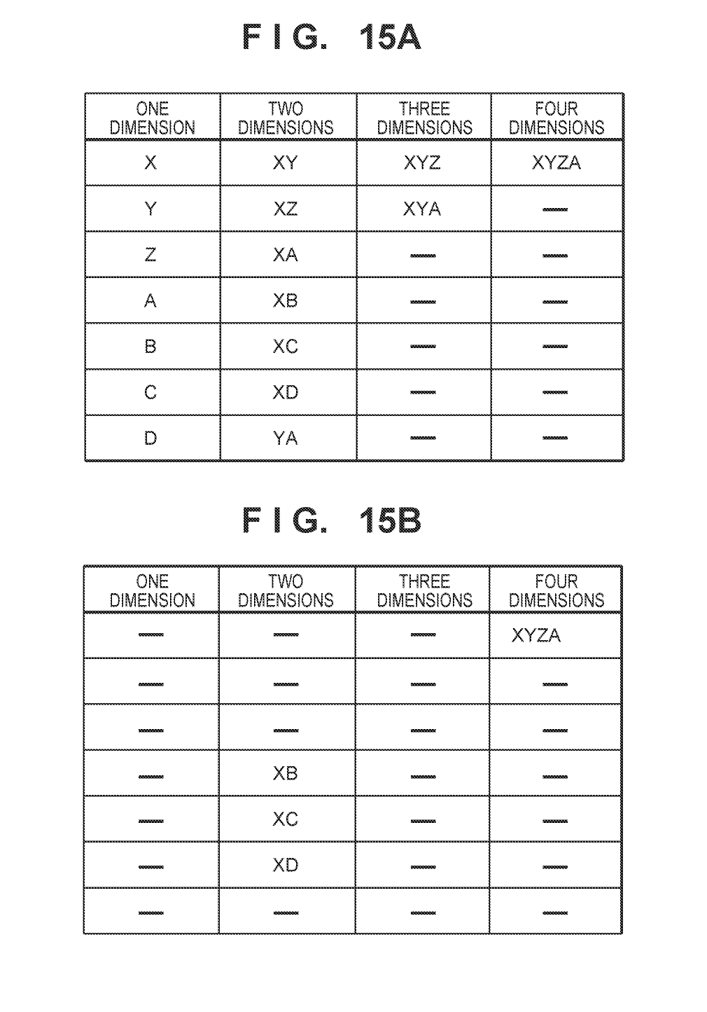

Finally, for interpolation calculation performed for presentation of a rendering object in a state corresponding to an arbitrary parameter value set, a comparison of calculation efficiency will be given between the method described in Japanese Patent Laid-Open No. 2009-104570, the method performed using the parameter table and the keyform table when editing in the keyform editing application of the present embodiment, and the method performed using the parameter table for output and the keyform table for output at runtime. Note that evaluation conditions are that seven types of parameters are associated with a rendering object, two parameter keys are defined for each parameter, it is defined whether or not there is relatedness between parameters (formation of a multi-dimensional parameter space), as illustrated in FIG. 15A, and an efficiency evaluation is performed by maximum number of interpolation calculations and maximum number of keys for which state information is referenced until completion of the interpolation calculation (total number of reference keys).

First, in the method described in Japanese Patent Laid-Open No. 2009-104570, since there is no concept of parameter spaces of different numbers of dimensions, interpolation calculation is performed for a seven dimension parameter space formed by all of the parameters in the case where the seven types of parameters are associated with the rendering object. Accordingly, since there is one type of parameter space that is the target of the interpolation calculation,

the number of interpolation calculations: 1. Meanwhile, the total reference key number until the completion of the interpolation calculation, since it is a seven dimension parameter space, by combination of all parameter keys,

the total reference key number: 2⁷=128.

Next, in the method used when editing in the keyform editing application of the present embodiment, as illustrated in FIG. 15A, parameter spaces from one dimension to four dimensions are managed, and since an interpolation calculation is performed for each of these,

the number of interpolation calculations: 7+7+2+1=17. Meanwhile, for the total reference key number until the completion of the interpolation calculation, since references are performed for each of seven types of one-dimensional parameter spaces, seven types of two-dimensional parameter spaces, two types of three-dimensional parameter spaces, and four types of four-dimensional parameter spaces,

the total reference key number; 2*7+2²*7+2³*2+2⁴*1=74.

Finally, in the method used at runtime of the present embodiment, since the parameter spaces are integrated as illustrated in FIG. 15B,

the number of interpolation calculations: 3+1=4. Meanwhile, for the total reference key number until completion of the interpolation calculation, since reference is performed for each of the three types of two-dimensional parameter spaces and one type of four-dimensional parameter space,

the total reference key number: 2²*3+2⁴*1=28.

Accordingly, from the perspective of the number of memory accesses according to state information references, a reduction in the calculation load according to the interpolation calculation is realized. Also, while the number of interpolation calculations may increase, the number of weighted addition in one interpolation calculation, in the method described in Japanese Patent Laid-Open No. 2009-104570 is 2⁷, in the method used when editing is it a maximum of 2⁴, and in the method used at runtime it is a maximum of 2⁴, and therefore it is possible to reduce calculation scale and it is possible to reduce the memory region that should be allocated upon performing the calculation.

As described above, by virtue of the apparatus of the present embodiment, it becomes possible to make desired rendering expression adjustment easy and reduce the calculation load.

[Variation]

In the above described embodiment, description is given of something in which, for a plurality of types of parameters that are associated, an arbitrary parameter key set is selected, and keyform definition is performed, but implementations of the present invention are not limited to this.

For example, it is ideal that parameters for transparency modification, effects, or the like, be applied commonly to the entirety of a rendering object independent of state transitions of the rendering object due to other parameters, and there is little merit in purposely defining multi-dimensional parameter space keyforms that include combinations of parameter keys of such parameters. In other words, there is the possibility that, by allowing keyform definition that considers a combination of such a parameter and other parameters, an unintended state transition will end up being defined.

Accordingly, keyform definition for such parameters may be performed independently only for these parameters, and when associating parameters, information indicating an absolute exclusive attribute that absolutely excludes combination with other parameters, for example, may be associated with these parameters. In such a case, configuration may be taken such that, when a parameter of this absolute exclusive attribute is set for a parameter key other than a reference value, and when another parameter is set for a parameter key other than a reference value, control is performed such that an edit operation on a rendering object according to a definition of a keyform for that parameter key set becomes impossible.

Also, there are situations in which, in order to stipulate lip motion of a character, for example, in relation to basic state transitions for opening and closing of a mouth, assignment of parameters for further adjusting the opening and closing shape (round-type, upside-down triangle-type), is desired (not limited to opening and closing of a mouth). Meanwhile, for respective parameters for adjustment that are tacked on in relation to such basic state transitions, destination targets differ, and it is difficult to envision situations of simultaneous parameter modification, there is little merit in defining multi-dimensional parameter space keyforms that include combinations of parameter keys of such parameters for adjustment.

Accordingly, for definition of keyforms for such parameters for adjustment, combinations of these parameters only or with the basic parameters are sufficient, and at the time of parameter association, information indicating a partially exclusive attribute that excludes only combinations with parameters for adjustment, for example, may similarly be associated with these parameters. In such a case, in a case where there are a plurality of parameters of the partially exclusive attribute for which a parameter key that is not a reference value is set, control may be performed such that an edit operation on a rendering object according to a definition of a keyform for that parameter key set becomes impossible. Also, in a case where there is only one parameter of the partially exclusive attribute for which a parameter key that is not a reference value is set, or none exist, control may be performed such that an edit operation on a rendering object according to a definition of a keyform for that parameter key set becomes impossible.

In this way, it is possible to control operation on the keyform editing application side so that a user, by setting as appropriate the absolute exclusive attribute or the partly exclusive attribute at the time of association of a parameter in advance in a case where a usage application or the like has been confirmed for a keyform definition according to a combination of a plurality of types of parameter keys, can avoid unnecessary multi-dimensional parameter space definition and keyform definition being performed, and reduce the calculation amount according to derivation of state information.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. Also, the rendering method according to the present invention are realizable by a program executing the methods on one or more computers. The program is providable/distributable by being stored on a computer-readable storage medium or through an electronic communication line.

This application claims the benefit of U.S. Provisional Patent Application No. 62/485,257, filed Apr. 13, 2017, and the benefit of Japanese Patent Application No. 2017-108294, filed May 31, 2017, which are hereby incorporated by reference herein in their entirety.

What is claimed is:

1. A non-transitory computer readable storage medium storing a program for presenting a rendering object for a requested state, wherein
the program causes a computer, comprising a memory in which an attribute table that manages a plurality of types of attributes arranged for the rendering object and whether or not there is relatedness between attributes and a state table that manages an attribute value set for which a state definition was performed and state information indicating a corresponding defined state, to execute:
processing for obtaining a presentation attribute value set configured by attribute values that identify a state of the rendering object for which a presentation request was made;
processing for deciding, for the state for which the presentation request was made, attribute spaces for which to perform an interpolation calculation for state information based on the presentation attribute value set, the attribute table, and the state table;
processing for deriving state information of the state for which the presentation request was made by performing the interpolation calculation for each of the decided attribute spaces; and
processing for presenting the rendering object based on the derived state information,
wherein
a reference state, which is identified by the plurality of types of attribute values all being reference values, is defined for the rendering object,
each of the plurality of types of attributes and each group of attributes having relatedness form an individual attribute space, and
the state table manages a difference of state information from the reference state for the defined state as difference information by separation into corresponding attribute spaces, and
in the processing for deriving,
for each of the decided attribute spaces, the interpolation calculation is performed by using the difference information which is managed for a state defined for that attribute space, and
the state information of the state for which the presentation request was made is derived by adding a sum total of interpolation calculation results of the decided attribute spaces to state information of the reference state.

2. The storage medium according to claim 1, wherein an attribute space comprises a number of dimensions according to a number of attributes that are associated, and
in the state table, the difference of state information from the reference state for the defined state is managed by separation into a first attribute space formed by all of a group of attributes of an attribute value set for which that state definition was performed and a second attribute space of a number of dimensions lower than the first attribute space which is formed by a portion of the attributes of the attribute value set for which that state definition was performed.

3. The storage medium according to claim 2, wherein the difference information managed by the first attribute space for the defined state is a difference from state information derived by adding to state information of the reference state a sum total of the difference information managed by the second attribute space for that defined state.

4. The storage medium according to claim 2, wherein the attribute spaces decided in the processing for deciding are attribute spaces formed by at least one attribute of the presentation attribute value set.

5. The storage medium according to claim 4, wherein in the processing for deriving, the interpolation calculation is not performed for an attribute space for which the defined state does not exist, among the decided attribute spaces.

6. The storage medium according to claim 2, wherein for each of the plurality of types of attributes, a definition point for an attribute value included in the attribute value set for which the state definition was performed, including a reference value is arranged, and
the interpolation calculation for state information of the state for which the presentation request was made is performed by targeting, for each attribute associated with the decided attribute spaces, a section that is indicated by two of the definition point and that include a value of the same attribute of the presentation attribute value set in a range.

7. The storage medium according to claim 6, wherein in the interpolation calculation performed for each of the decided attribute spaces, in a case where a state definition has not been performed for an attribute value set configured by a combination of the definition point, which will be a target of that interpolation calculation for an attribute space, the difference information, which indicates that there is no difference, is used for a state identified by that attribute value set.

8. The storage medium according to claim 2, wherein the program further causes the computer to execute processing for updating the state table in accordance with a state of the rendering object being edited, and
the processing for updating includes
processing for obtaining an editing attribute value set that identifies the edited state, and
processing for registering in the state table a difference of state information from the reference state for the edited state.

9. The storage medium according to claim 8, wherein the processing for updating further includes processing for adjusting, for a state that is defined in a fourth attribute space of a number of dimensions that is higher than a third attribute space formed by all of the group of attributes of the editing attribute value set and for which state information is derived by using the difference information that is managed by the third attribute space for the edited state, such that state information of that state does not change between before and after editing.

10. The storage medium according to claim 9, wherein the state table further manages, for each of the defined state, information indicating whether or not state information is allowed to change in accordance with editing that is performed in relation to an attribute space of a lower number of dimensions, and
in a case where the information indicating that the state information is not allowed to change in accordance with editing is managed for a state defined for the fourth attribute space, the processing for the adjusting is executed.

11. The storage medium according to claim 8, wherein the attribute table, for each of the plurality of types of attributes, further manages information indicating whether or not to allow an association with another attribute,
and in a case where the editing attribute value set includes a plurality of attributes indicating an attribute value other than a reference value and includes an attribute for which an association between that plurality of attributes and the another attribute is not allowed, the processing for registering is controlled to not be executed.

12. The storage medium according to claim 2, wherein the program further causes the computer to execute
processing for integrating attribute spaces formed for the rendering object into attribute spaces that include all of associated attributes and has a higher number of dimensions,
processing for converting, for each of the post-integration attribute spaces, an attribute value set that identifies a state that is defined for an attribute space used in the integration into an attribute value set configured by attribute values of a group of attributes associated with that post-integration attribute space,
processing for generating, for each of the post-integration attribute spaces, difference information of a state defined in the post-integration attribute space, based on the difference information being managed in an attribute space used for the integration, and
processing for outputting a new state table that manages the converted attribute value sets and the generated difference information corresponding to those attribute value sets,
wherein
the difference information of the state defined for the post-integration attribute space is a value resulting from adding the difference information that was being managed by an attribute space having a number of dimensions that is lower than that attribute space prior to the integration and that is used for the integration to the difference information that was being managed by an attribute space for which that state was defined prior to the integration.

13. The storage medium according to claim 12, wherein in a case where, for one attribute space prior to the integration, a plurality of attribute spaces including all attributes associated with that one attribute space and having a higher number of dimensions are present for the same number of dimensions, in the processing for the generating, a value that divides the difference information that was being managed in the one attribute space by the number of attribute spaces present for that same number of dimensions is added in the integration.

14. A rendering method for presenting a rendering object for a requested state, comprising:
obtaining an attribute table that manages a plurality of types of attributes arranged for the rendering object and whether or not there is relatedness between attributes and a state table that manages an attribute value set for which a state definition was performed and state information indicating a corresponding defined state;
obtaining a presentation attribute value set configured by attribute values that identify a state of the rendering object for which a presentation request was made;
deciding, for the state for which the presentation request was made,
attribute spaces for which to perform an interpolation calculation for state information based on the presentation attribute value set, the attribute table, and the state table;
deriving state information of the state for which the presentation request was made by performing the interpolation calculation for each of the decided attribute spaces; and
presenting the rendering object based on the derived state information,
wherein
a reference state, which is identified by the plurality of types of attribute values all being reference values, is defined for the rendering object,
each of the plurality of types of attributes and each group of attributes having relatedness form an individual attribute space, and
the state table manages a difference of state information from the reference state for the defined state as difference information by separation into corresponding attribute spaces, and
in the deriving,
for each of the decided attribute spaces, the interpolation calculation is performed by using the difference information which is managed for a state defined for that attribute space, and
the state information of the state for which the presentation request was made is derived by adding a sum total of interpolation calculation results of the decided attribute spaces to state information of the reference state.

15. A data structure that is used for presenting a rendering object for a requested state, and that manages states of that rendering object for which a state definition was performed, the data structure comprising:
first information that manages a plurality of types of attributes arranged for the rendering object and whether or not there is relatedness between attributes; and
second information that manages an attribute value set for which a state definition was performed and state information indicating a corresponding defined state,
wherein
a reference state, which is identified by the plurality of types of attribute values all being reference values, is defined for the rendering object,
each of the plurality of types of attributes and each group of attributes having relatedness form an individual attribute space, and
the second information manages a difference of state information from the reference state for the defined state as difference information by separation into corresponding attribute spaces.
